(19) United States
(12) Patent Application Publication
(10) Pub. No.: US 2018/0213020 A1
(43) Pub. Date: Jul. 26, 2018

(54) INFORMATION PROCESSING APPARATUS THAT RECORDS REMOTE SUPPORT OPERATION LOG, REMOTE SUPPORT SYSTEM, METHODS OF CONTROLLING THESE, AND STORAGE MEDIUM

(71) Applicant: CANON KABUSHIKI KAISHA, Tokyo (JP)

(72) Inventors: Naoya Kakutani, Kashiwa-shi (JP); Kazuhiro Uruma, Moriya-shi (JP)

(21) Appl. No.: 15/874,015

(22) Filed: Jan. 18, 2018

(30) Foreign Application Priority Data
Jan. 24, 2017 (JP) 2017-010397

(51) Int. Cl. H04L 29/08; H04Q 9/04

(52) U.S. Cl. CPC H04L 67/025; H04L 29/06897; H04Q 9/04; H04L 67/125

(57) ABSTRACT

An information processing apparatus capable of presenting an audit trail of operations performed during remote support to a user. A multifunction peripheral for which remote support is performed by an operator PC connected thereto via a network. A log of operations in the operator PC and the multifunction peripheral is recorded. The function of log recording is set to be enabled on the multifunction peripheral, and is enabled in a time period from start to end of remote support.

### BACKGROUND OF THE INVENTION

### Field of the Invention

The present invention relates to an information processing apparatus that records a remote support operation log, a remote support system, methods of controlling these, and a storage medium.

### Description of the Related Art

As how to use a product, such as a multifunction peripheral, becomes more complicated and how to cope with a trouble during the use thereof also becomes more complicated, a situation more frequently occurs in which a customer directly asks a question of the call center of a manufacturer of the product, and obtains an answer to the question therefrom. To perform proper and quick troubleshooting, it is envisaged to provide a remote support system which includes multifunction peripherals and a failure management server provided at the call center for managing error information of the multifunction peripherals. The remote support system may be configured such that any multifunction peripheral receives remote support, and an information processing apparatus, such as a PC, provides the remote support. In this case, an operator of the information processing apparatus remotely operates the user interface of the multifunction peripheral to thereby perform proper settings configuration of the multifunction peripheral or provide operation instructions to the multifunction peripheral.

In the above-described remote support system, there has been proposed a method in which an operator remotely operates the multifunction peripheral receiving the support from the information processing apparatus of the call center to thereby provide the support. In this remote support system, it is possible to operate and check software of the customer's multifunction peripheral receiving the remote support from the information processing apparatus at the call center.

For example, in a remote support system disclosed in Japanese Laid-Open Patent Publication (Kokai) No. 2012-203813, a screen of a PC of a customer is captured and transmitted, whereby an operator can quickly grasp the state of a trouble. More specifically, the remote support system proposes a method in which the customer makes a call to the call center to notify the operator of the call center of a trouble of the multifunction peripheral, and the operator of the call center provides the support by remotely operating the multifunction peripheral using the information processing apparatus.

However, in such a remote support system as disclosed in Japanese Laid-Open Patent Publication (Kokai) No. 2012-203813, unless the user of the multifunction peripheral performs in-situ observation of the user interface of the multifunction peripheral, the user cannot know what operations have been remotely performed on the multifunction peripheral by the operator. Therefore, after termination of the remote support, in a case where an audit trail of the operations performed during the remote support is requested by the user, the operator cannot present the requested information to the user.

### SUMMARY OF THE INVENTION

The present invention provides an information processing apparatus that makes it possible to present an audit trail of operations performed during remote support to a user, a remote support system, methods of controlling these, and a storage medium.

In a first aspect of the present invention, there is provided an information processing apparatus for which remote support is performed by a remote supporting apparatus connected thereto via a network, comprising a log recording unit configured to record a log of operations performed in the remote supporting apparatus and the information processing apparatus, and an enabling unit configured to enable the log recording unit, wherein the enabling unit enables the log recording unit in a time period from start to end of the remote support.

In a second aspect of the present invention, there is provided a remote support system that connects a remote supporting apparatus and an information processing apparatus for which remote support is performed, via a network, comprising a log recording unit configured to record a log of operations in the remote supporting apparatus and the information processing apparatus, by a recording device connected thereto via the network, and an enabling unit configured to enable the log recording unit, by the information processing apparatus, wherein the enabling unit enables the log recording unit in a time period from start to end of the remote support.

In a third aspect of the present invention, there is provided a method of controlling an information processing apparatus for which remote support is performed by a remote supporting apparatus connected thereto via a network, comprising recording a log of operations in the remote supporting apparatus and the information processing apparatus, and enabling said recording of the log, wherein said recording of the log is enabled in a time period from start to end of the remote support.

In a fourth aspect of the present invention, there is provided a method of controlling a remote support system that connects a remote supporting apparatus and an information processing apparatus for which remote support is performed, via a network, comprising recording a log of operations in the remote supporting apparatus and the information processing apparatus, in a recording device connected to the network, and enabling said recording of the log, in the information processing apparatus, wherein said recording of the log is enabled in a time period from start to end of the remote support.

In a fifth aspect of the present invention, there is provided a non-transitory computer-readable storage medium storing a computer-executable program for executing a method of controlling an information processing apparatus for which remote support is performed by a remote supporting apparatus connected thereto via a network, wherein the method comprises recording a log of operations in the remote supporting apparatus and the information processing apparatus, and enabling said recording of the log, wherein said recording of the log is enabled in a time period from start to end of the remote support.

In a sixth aspect of the present invention, there is provided a non-transitory computer-readable storage medium storing a computer-executable program for executing a method of controlling a remote support system that connects a remote supporting apparatus and an information processing apparatus for which remote support is performed, via a network, wherein the method comprises recording a log of operations in the remote supporting apparatus and the information processing apparatus, in a recording device connected to the network, and enabling said recording of the log, in the information processing apparatus, wherein said recording of the log is enabled in a time period from start to end of the remote support.

According to the present invention, it is possible to present an audit trail of operations performed during remote support to a user.

Further features of the present invention will become apparent from the following description of exemplary embodiments (with reference to the attached drawings).

### BRIEF DESCRIPTION OF THE DRAWINGS

FIG. 1 is a diagram showing network configuration of a remote support system according to a first embodiment of the present invention.

FIG. 2 is a block diagram of hardware configuration of the remote support system shown in FIG. 1.

FIG. 3 is a flowchart of a remote support process performed by a multifunction peripheral, appearing in FIG. 1, of the remote support system according to the first embodiment.

FIG. 4 is a continuation of FIG. 3.

FIG. 5 is a flowchart of a remote support process performed by an operator PC, appearing in FIG. 1, of the remote support system according to the first embodiment.

FIG. 6 is a flowchart of a remote support process performed by a relay server, appearing in FIG. 1, of the remote support system according to the first embodiment.

FIG. 7 is a diagram showing an example of a remote support start request screen displayed in a step in FIG. 3.

FIG. 8 is a diagram showing an example of a log recording function-setting screen displayed according to the log recording configuration acquired in a step in FIG. 3.

FIG. 9 is a flowchart of an operation log-recording process performed by the multifunction peripheral of the remote support system according to the first embodiment.

FIG. 10 is a block diagram of software functions of the multifunction peripheral.

FIG. 11 is a flowchart of a remote support process performed by a multifunction peripheral of a remote support system according to a second embodiment of the present invention.

FIG. 12 is a continuation of FIG. 11.

FIG. 13 is a diagram showing an example of a log encryption-setting screen displayed in a step in FIG. 11.

FIG. 14 is a diagram showing network configuration of a remote support system according to a third embodiment of the present invention.

FIG. 15 is a block diagram of hardware configuration of the remote support system shown in FIG. 14.

FIG. 16 is a flowchart of a remote support process performed by a multifunction peripheral, appearing in FIG. 14, of the remote support system according to the third embodiment.

FIG. 17 is a continuation of FIG. 16.

FIG. 18 is a flowchart of a remote support process performed by an operator PC, appearing in FIG. 14, of the remote support system according to the third embodiment.

FIG. 19 is a flowchart of a remote support process performed by a relay server, appearing in FIG. 14, of the remote support system according to the third embodiment.

FIGS. 20A and 20B are diagrams each showing an example of a remote support start request screen displayed in a step in FIG. 16.

FIG. 21 is a flowchart of a remote support process performed by a multifunction peripheral of a remote support system according to a fourth embodiment of the present invention.

FIG. 22 is a continuation of FIG. 21.

FIG. 23 is a diagram showing an example of a log encryption-setting screen displayed on the multifunction peripheral of the remote support system according to the fourth embodiment.

### DESCRIPTION OF THE EMBODIMENTS

The present invention will now be described in detail below with reference to the accompanying drawings showing embodiments thereof.

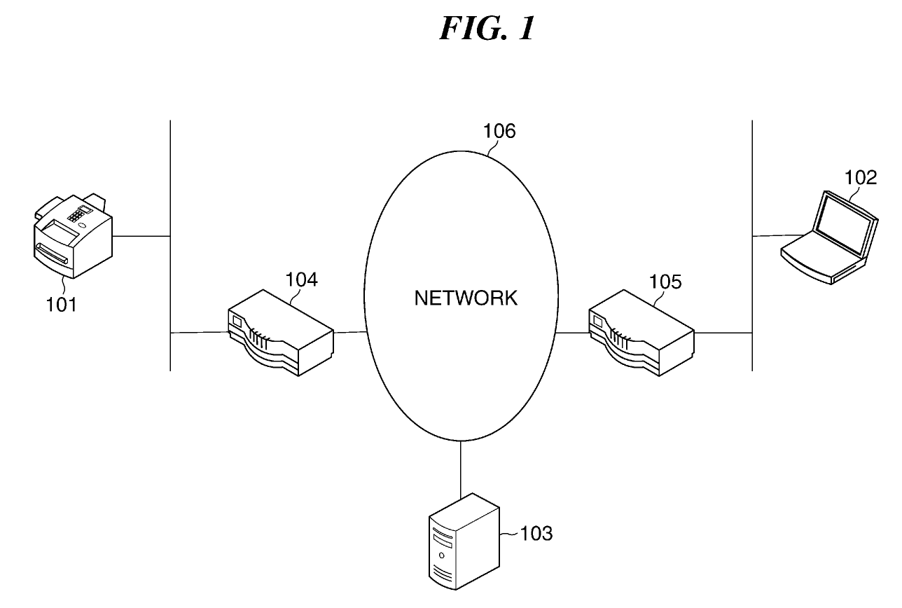

FIG. 1 is a diagram showing network configuration of a remote support system according to a first embodiment of the present invention. In the present embodiment, a multifunction peripheral 101 and an operator PC 102 function as an information processing apparatus and a remote supporting apparatus of the present invention, respectively, and operate as mutual communication partners.

In the present embodiment, using a report acquisition function of an application program installed in the operator PC 102, an operator can acquire status information of the multifunction peripheral 101, such as apparatus configuration information, wearing conditions, and operation conditions. Further, using a function for accessing a web server installed on the multifunction peripheral 101 via a web browser (remote user interface function), the operator can change settings of the multifunction peripheral 101, confirm images and print data, stored in an HDD (Hard Disk Drive) 205 of the multifunction peripheral 101, and manage application programs. Further, using a content sharing function via the web browser, the operator can cause contents, such as a support manual, to be displayed on an operation panel 212 of the multifunction peripheral 101, remotely from the operator PC 102. Further, the operator can start up a user interface application server, such as Java (registered trademark), on the multifunction peripheral 101, and control a Java client application on the operator PC 102 to display a native operation screen of the multifunction peripheral 101 on the operator PC 102 as an image. This may be realized by implementing e.g. an X server or a remote desktop function, using a function of an OS.

The multifunction peripheral 101 and the operator PC 102 each have a data communication function for performing data communication by executing call control using the HTTP (Hyper Text Transfer Protocol). Such remote support as described above is similarly performed in second to fourth embodiments, described hereinafter.

The multifunction peripheral 101 is connected to a network 106 via a firewall (FW) 104. Further, the operator PC 102 on the call center side is connected to the network 106 via a firewall 105. Further, an HTTP relay server 103 is connected to the network 106.

In data communication using the HTTP, client nodes perform data communication with each other by sending a POST/GET request to a URI (Uniform Resource Identifier) provided by the HTTP relay server 103 (hereinafter referred to as the “relay server 103”). This enables the client nodes to perform data communication with each other even if the client nodes are blocked from each other by a private address area or a firewall. In the present embodiment, the multifunction peripheral 101 and the operator PC 102 each operate as an HTTP client node. Further, although in the present embodiment, communication between the client nodes is performed via the firewalls 104 and 105 over the network 106, the network configuration without using firewalls may be employed. Further, larger numbers of firewalls, multifunction peripherals, and operator PCs than those illustrated in FIG. 1 may be connected to the network 106, and the communication protocol is not limited to the HTTP.

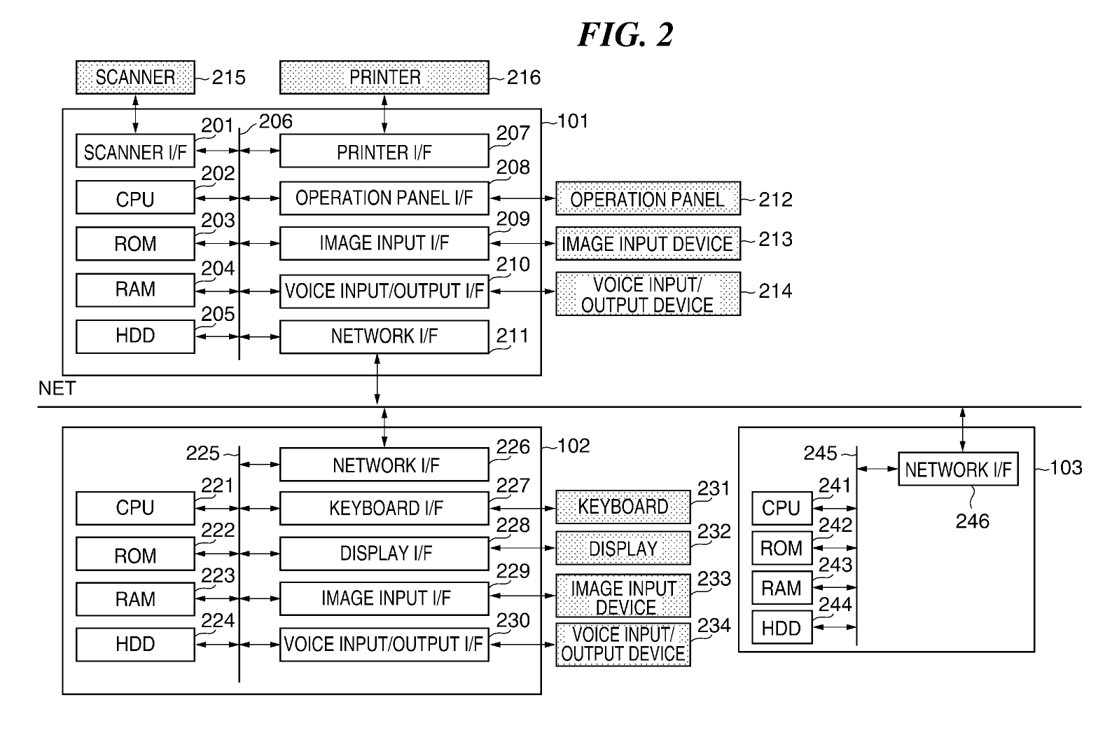

FIG. 2 is a block diagram of hardware configuration of the remote support system shown in FIG. 1. In the multifunction peripheral 101, reference numeral 202 denotes a CPU which performs centralized control of accesses to various devices connected to a system bus 206 based on control programs stored in a ROM 203 or the HDD 205.

The ROM 203 stores the control programs which can be executed by the CPU 202, and so forth.

Reference numeral 204 denotes a RAM which mainly functions as a main memory, a work area, and so forth, for the CPU 202, and is configured such that its memory capacity can be expanded by an option RAM connected to an expansion port, not shown.

The HDD 205 stores a boot program, various application programs, font data, user files, editing files, and so forth. Note that although the HDD 205 is used in the present embodiment, not only the HDD 205, but also an SD card or a flash memory may be used as an external storage device. Reference numeral 201 denotes a scanner interface which controls inputting of an image from a scanner 215.

Reference numeral 207 denotes a printer interface which controls image output to a printer 216.

Reference numeral 208 denotes an operation panel interface which controls the display of an operation panel 212, and input of various setting information set on the operation panel 212.

Reference numeral 209 denotes an image input interface which controls image input from an image input device 213, such as a camera.

Reference numeral 210 denotes a voice input/output interface which controls input and output of a voice to and from a voice input/output device 214, such as a headset.

Reference numeral 211 denotes a network interface which performs data communication with an external network (network 106) via a network cable.

In the operator PC 102, reference numeral 221 denotes a CPU which performs centralized control of accesses to various devices connected to a system bus 225 based on control programs stored in a ROM 222 or an HDD 224.

The ROM 222 stores control the programs which can be executed by the CPU 221, and so forth.

Reference numeral 223 denotes a RAM which mainly functions as a main memory, a work area, and so forth, for the CPU 221, and is configured such that its memory capacity can be expanded by an option RAM connected to an expansion port, not shown.

The HDD 224 stores a boot program, various application programs, font data, user files, editing files, and so forth. Note that although the HDD 224 is used in the present embodiment, not only the HDD 224, but also an SD card or a flash memory may be used as an external storage device. Reference numeral 225 denotes the system bus.

Reference numeral 226 denotes a network interface which performs data communication with an external network (network 106) via a network cable.

Reference numeral 227 denotes a keyboard interface which controls key input from a keyboard 231 or a pointing device, not shown.

Reference numeral 228 denotes a display interface which controls the display of a display 232.

Reference numeral 229 denotes an image input interface which controls input of an image from an image input device 233, such as a camera.

Reference numeral 230 denotes a voice input/output interface which controls input and output of a voice to and from a voice input/output device 234, such as a headset.

In the relay server 103, reference numeral 241 denotes a CPU, which performs centralized control of accesses to various devices connected to a system bus 245 based on control programs stored in a ROM 242 or a HDD 244.

The ROM 242 stores the control programs which can be executed by the CPU 241, and so forth. Reference numeral 243 denotes a RAM which mainly functions as a main memory, a work area, and so forth, for the CPU 241, and is configured such that its memory capacity can be expanded by an option RAM connected to an expansion port, not shown.

The HDD 244 stores a boot program, various application programs, font data, user files, editing files, and so forth.

Note that although the HDD 244 is used in the present embodiment, not only the HDD 244, but also an SD card or a flash memory may be used as an external storage device.

Reference numeral 246 denotes a network interface which performs data communication with an external network (network 106) via a network cable.

A description will be given of a flow of the overall operations of the remote support system according to the present embodiment. First, the multifunction peripheral 101 accesses the relay server 103, and is on standby for reception of video data. Then, the operator PC 102 accesses the relay server 103, and starts to transmit the video data.

With this, the multifunction peripheral 101 receives the video data, and becomes capable of displaying a video of remote support on the operation panel 212. The following description is given of details of processing operations associated with remote support processes performed by the multifunction peripheral 101, the operator PC 102, and the relay server 103, respectively.

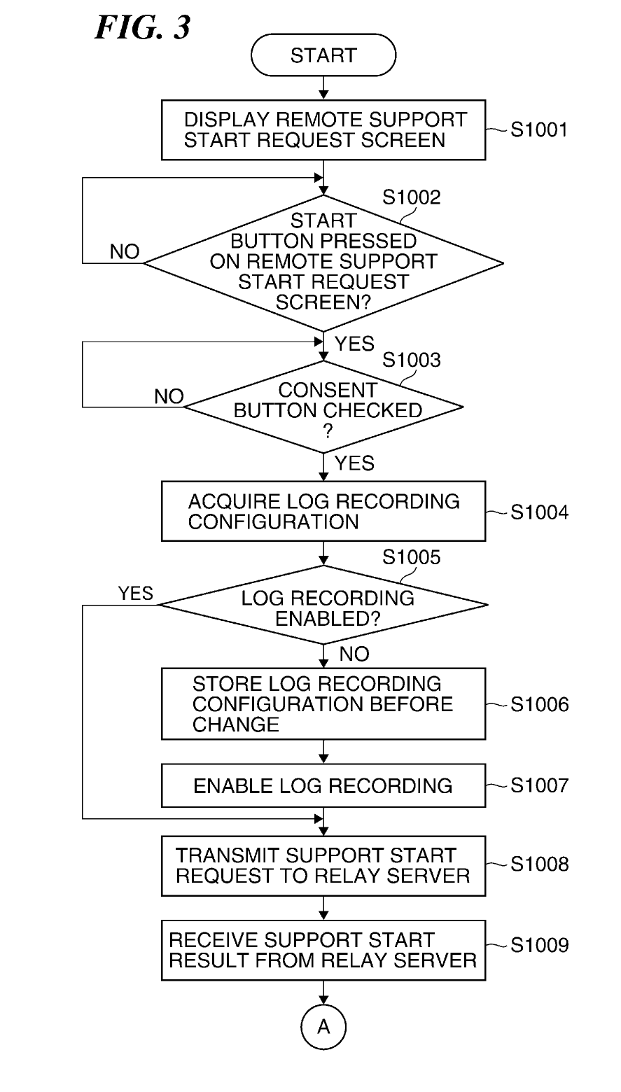

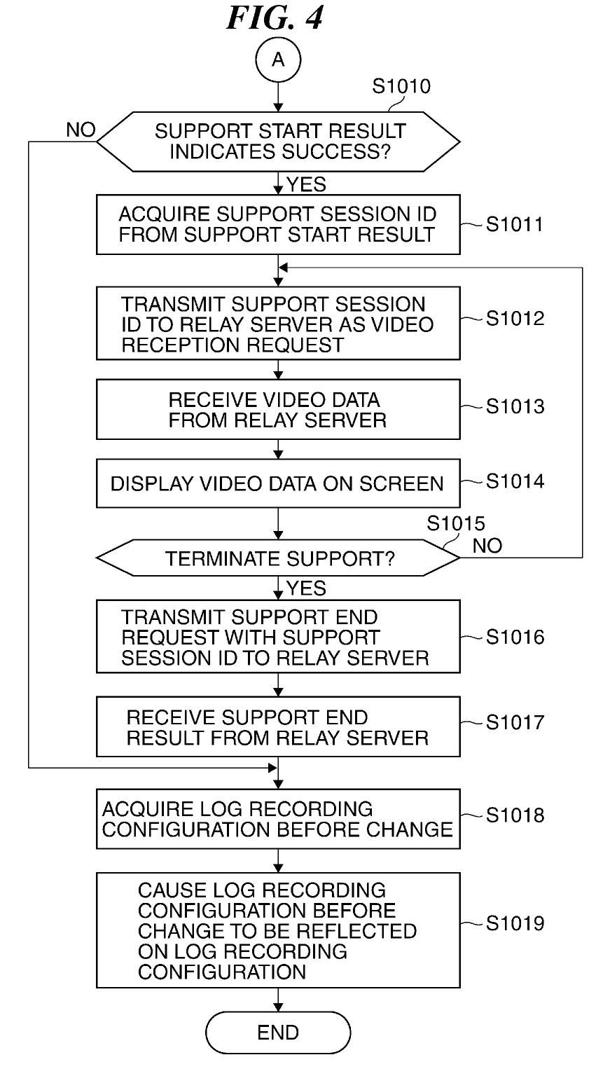

FIGS. 3 and 4 are a flowchart of a remote support process performed by the multifunction peripheral 101, appearing in FIG. 1, of the remote support system according to the present embodiment.

This remote support process is realized by the CPU 202 executing a program stored in the HDD 205 and loaded into the RAM 204.

Referring to FIG. 3, first, the multifunction peripheral 101 displays a remote support start request screen 06001 on the operation panel 212 (step S1001).

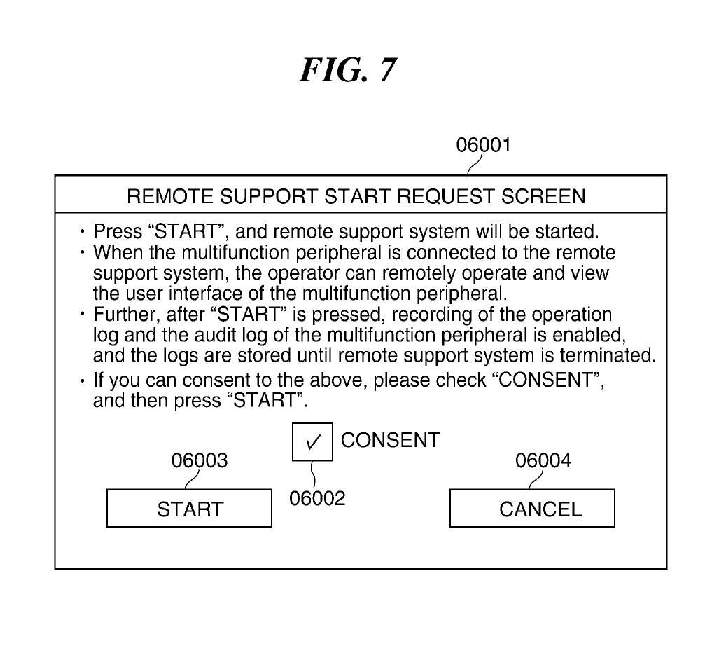

FIG. 7 shows an example of the remote support start request screen 06001 displayed in the step S1001 in FIG. 3. In the illustrated example of FIG. 7, the remote support start request screen 06001 includes a consent checkbox 06002, a remote support start button 06003, and a cancel button 06004. Further, the remote support start request screen 06001 has notifications of points to keep in mind and points to which the user is required to consent before starting remote support. The illustrated example of the remote support start request screen 06001 displays a notification that logs start to be recorded when remote support is started. In a case where the user consents to the described points, the user checks the consent checkbox 06002 via the operation panel 212.

Next, the multifunction peripheral 101 determines whether or not the start button (the remote support start button 06003 in FIG. 7) has been pressed on the remote support start request screen 06001 (step S1002).

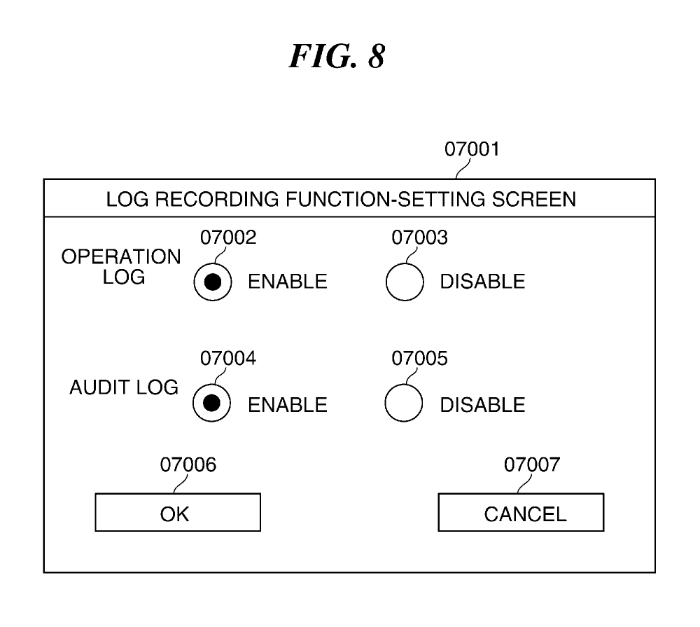

If it is determined that the remote support start button 06003 has been pressed, the multifunction peripheral 101 determines whether or not the consent checkbox 06002 is checked (step S1003). If it is determined that the consent checkbox 06002 is checked, the multifunction peripheral 101 acquires the current log recording configuration from the RAM 204 (step S1004). The log recording configuration to be acquired is set on a log recording function-setting screen 07001, shown in FIG. 8, which is displayed on the operation panel 212, and is stored in the RAM 204. The log recording function of the multifunction peripheral 101 is controlled according to the settings of the log recording configuration. The log recording configuration is stored in the HDD 205 when the multifunction peripheral 101 is shut down, and is loaded from the HDD 205 into the RAM 204 as the current log recording configuration at the startup of the multifunction peripheral 101. The log recording configuration is changed by an operation on the log recording function-setting screen on an as-needed basis.

In the illustrated example of FIG. 8, the log recording function-setting screen 07001 includes an operation log enable button 07002, an operation log disable button 07003, an audit log enable button 07004, and an audit log disable button 07005. The operation log refers to a log of operation performed by an operator on the multifunction peripheral 101, directly or via the operator PC 102, and the log records information on the operation screen, coordinates therein, and so forth. The audit log refers to a log which records information on a user who logged in the multifunction peripheral 101, history of jobs executed by the multifunction peripheral 101, and so forth. In the present embodiment, the settings on which the selected states of these buttons 07002 to 07005 are reflected are referred to as the log recording configuration. In the multifunction peripheral 101, when a log recording function setting completion button 07006 is pressed, the log recording configuration is made valid. When a cancel button 07007 is pressed, operations so far performed on the log recording function-setting screen 07001 are canceled. Although in the present embodiment, the logs are classified into the two types, i.e. the audit log and the operation log, the types of logs are not limited. Further, the log recording function-setting screen 07001 may be configured such that a single setting can enable or disable a plurality of logs.

When the current log recording configuration is acquired from the RAM 204, next, the multifunction peripheral 101 determines whether or not settings of the acquired log recording configuration enable log recording, according to what the user consents on the remote support start request screen 06001, which corresponds to the settings shown in FIG. 8 (step S1005).

If it is determined that log recording is set to be enabled in the acquired log recording configuration (YES to the step S1005), more specifically, if it is determined that both of the audit log and the operation log are enabled, it is not required to change the current log recording configuration, and hence the multifunction peripheral 101 directly proceeds to a step S1008.

On the other hand, if it is determined that log recording is set to be disabled in the acquired log recording configuration (NO to the step S1005), more specifically, if it is determined that one of the audit log and the operation log is disabled, the multifunction peripheral 101 proceeds to a step S1006.

In the step S1006, the multifunction peripheral 101 stores the acquired current log recording configuration in the HDD 205 as the log recording configuration before change. Next, the multifunction peripheral 101 changes the log recording configuration in the RAM 204 such that log recording is enabled according to what the user consents on the remote support start request screen 06001, which corresponds to the settings shown in FIG. 8 (step S1007), and proceeds to the step S1008.

By executing the steps S1004 to S1007, when the multifunction peripheral 101 starts remote support processing, it is possible to positively record logs of the multifunction peripheral 101 based on the log recording configuration which enables the audit log and the operation log. This makes it possible to present an audit trail of the operations performed during remote support to the user.

Next, in the step S1008, the multifunction peripheral 101 transmits a support start request to the relay server 103. At this time, if the user of the multifunction peripheral 101 has been informed of a support session ID from an operator of the operator PC 102 via a telephone, the user inputs the support session ID on a support session ID input screen (not shown) displayed on the operation panel 212. In this case, the support session ID is caused to be contained in data of the transmitted support start request.

After transmission of the support start request is completed, the multifunction peripheral 101 receives a support start result from the relay server 103 (step S1009), and proceeds to a step S1010 in FIG. 4.

Referring to FIG. 4, the multifunction peripheral 101 determines whether or not the support start result received in the step S1009 indicates a success (step S1010). If the received support start result indicates a failure, the multifunction peripheral 101 proceeds to a step S1018. On the other hand, if the support start result indicates a success, the multifunction peripheral 101 acquires the support session ID from the received data (step S1011).

The support session ID is an identifier for performing remote support for the multifunction peripheral 101, which is issued by the relay server 103. When the support session ID has been acquired, the multifunction peripheral 101 transmits a video reception request to the relay server 103 (step S1012).

At this time, the multifunction peripheral 101 causes the support session ID acquired in the step S1011 to be contained in data of the transmitted video reception request. After transmission of the video reception request is completed, the multifunction peripheral 101 receives the video data from the relay server 103 (step S1013).

The reception processing in the step S1013 starts after the operator PC 102 transmits the video data, and hence, if the operator PC 102 has not transmitted the video data yet, the multifunction peripheral 101 continues to be on standby for the reception of the video data.

Next, the multifunction peripheral 101 displays the received video data on the operation panel 212 (step S1014). Remote support is performed by displaying the video based on the received video data on the operation panel 212.

When the processing for displaying the video in a predetermined time period is terminated, the multifunction peripheral 101 determines whether or not to terminate remote support (step S1015).

This determination may be performed based on the received data, or may be performed based on an input to the operation panel 212 of the multifunction peripheral 101. If it is determined that the support is not to be terminated, the multifunction peripheral 101 returns to the step S1012, and further receives video data. If it is determined that the support is to be terminated, the multifunction peripheral 101 transmits a support end request to the relay server 103 (step S1016).

At this time, the multifunction peripheral 101 causes the support session ID acquired in the step S1011 to be contained in data of the transmitted support end request. After transmission of the support end request is completed, the multifunction peripheral 101 receives a support end result from the relay server 103 (step S1017).

In the present embodiment, a time at which the multifunction peripheral 101 transmits the support start request to the relay server 103 in the step S1008 is defined as a remote support start, and a time at which the multifunction peripheral 101 receives the support end result from the relay server 103 in the step S1017 is defined as a remote support end. However, the definitions of the remote support start and the remote support end are not limited to these, but they may be defined using another time period (section). For example, a time at which the user consents to remote support in the step S1003 may be defined as the remote support start, and a time at which it is determined in the step S1015 that remote support is to be terminated may be defined as the remote support end. Further, a time at which the start button 06003 on the remote support start request screen 06001 is pressed (YES to the step S1002) may be defined as the remote support start.

After receiving the support end result from the relay server 103, the multifunction peripheral 101 acquires the log recording configuration before change from the HDD 205, which has been stored in the step S1006 (step S1018).

Next, the multifunction peripheral 101 causes the acquired log recording configuration before change to be reflected on the log recording configuration in the RAM 204 to set the same as the current log recording configuration (step S1019), followed by terminating the present process.

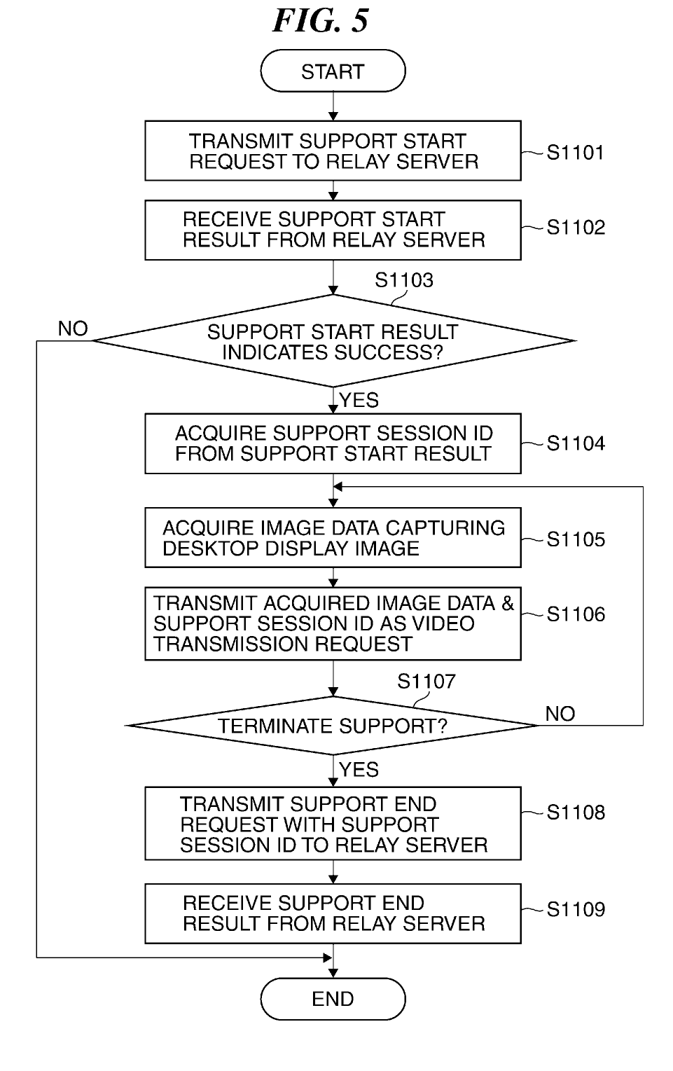

FIG. 5 is a flowchart of a remote support process performed by the operator PC 102, appearing in FIG. 1, of the remote support system according to the first embodiment. This remote support process is realized by the CPU 221 executing a program stored in the HDD 224 and loaded into the RAM 223.

First, the operator PC 102 transmits a support start request to the relay server 103 (step S1101). This support start request is transmitted when the call center receives a call for requesting remote support for the multifunction peripheral 101 e.g. from a user who is attending the multifunction peripheral 101. At this time, in a case where the operator of the operator PC 102 has been informed of a support session ID from the user of the multifunction peripheral 101 via a telephone, the operator of the operator PC 102 inputs the received support session ID on a support session ID input screen (not shown) displayed on the display 232. In this case, the support session ID is caused to be contained in data of the transmitted support start request.

After transmission of the support start request is completed, the operator PC 102 receives a support start result from the relay server 103 (step S1102).

Next, the operator PC 102 determines whether or not the support start result received in the step S1102 indicates a success (step S1103). If the support start result indicates a failure, the present process is immediately terminated.

On the other hand, if the support start result indicates a success, the operator PC 102 acquires the support session ID from the received data (step S1104).

When the support session ID has been acquired, the operator PC 102 acquires image data capturing an image of a desktop display screen (screen in which short-cut icons are arranged on a wallpaper) displayed on the display 232 thereof (step S1105).

When acquisition of the image data is completed, the operator PC 102 transmits a video transmission request to the relay server 103 (step S1106). At this time, the support session ID acquired in the step S1104 and the image data acquired in the step S1105 are caused to be contained in data of the transmitted video transmission request. The image data is transmitted to the multifunction peripheral 101 via the relay server 103 as the video data. The operator of the operator PC 102 performs remote support for the multifunction peripheral 101 using the video data.

The steps S1105 and S1106 are repeated until it is determined in a step S1107 that the support is to be terminated.

If it is determined in the step S1107 that the support is to be terminated, the operator PC 102 transmits a support end request to the relay server 103 (step S1108). At this time, the operator PC 102 causes the support session ID acquired in the step S1104 to be contained in data of the transmitted support end request.

After transmission of the support end request is completed, the operator PC 102 receives a support end result from the relay server 103 (step S1109), followed by terminating the present process.

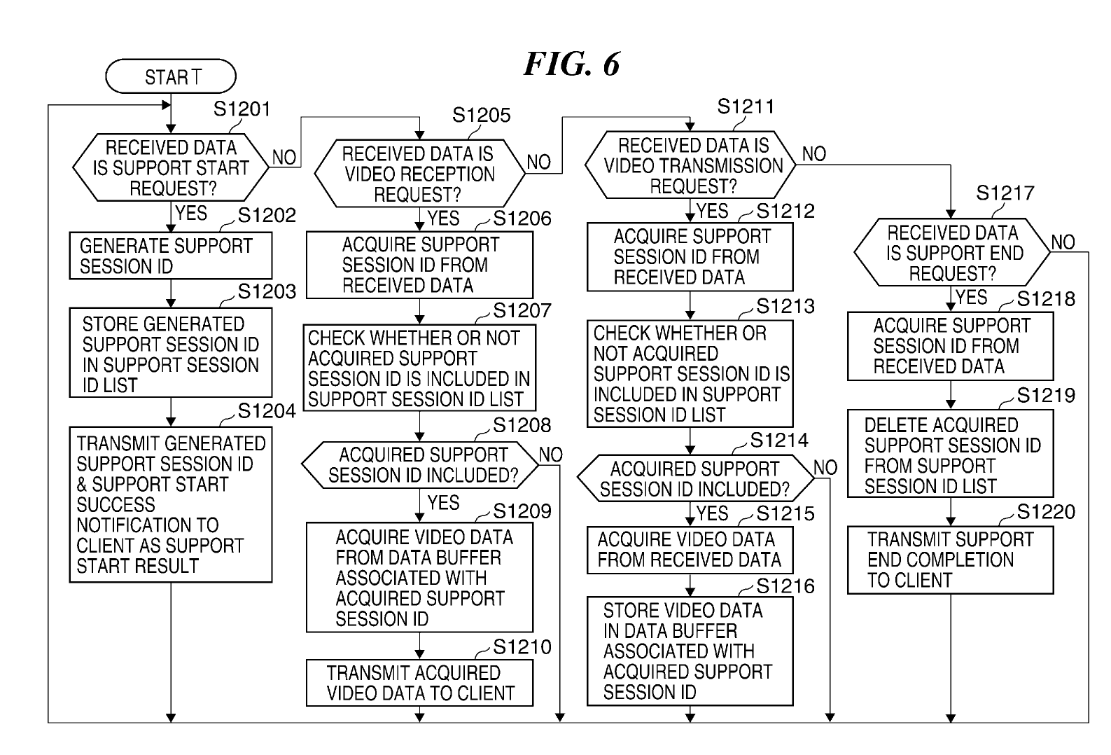

FIG. 6 is a flowchart of a remote support process performed by the relay server 103, appearing in FIG. 1, of the remote support system according to the first embodiment. This remote support process is realized by the CPU 241 executing a program stored in the HDD 244 and loaded into the RAM 243.

If the data received by the relay server 103 is a support start request transmitted from the multifunction peripheral 101 or the operator PC 102 (YES to a step S1201), the relay server 103 generates a support session ID (step S1202).

The relay server 103 stores the support session ID generated in the step S1202 in a support session ID list (step S1203).

The relay server 103 transmits the support session ID generated in the step S1202 and a support start success notification to the client as the support start result (step S1204). The client in the step S1204 is an apparatus having transmitted the support start request in the step S1201, and can be either of the multifunction peripheral 101 and the operator PC 102. After transmission of the support start result in the step S1204 is completed, the relay server 103 returns to the step S1201.

Note that in a case where a support session ID is included in the data of the support start request received in the step S1201, the support session ID is not generated in the step S1202, and the relay server 103 determines whether or not the received support session ID has already been stored in the support session ID list. If it is determined that the received support session ID has already been stored, the relay server 103 transmits the stored support session ID and the support start success notification as the support start result in the step S1204. On the other hand, if the received support session ID has not been stored, the relay server 103 transmits a support start failure notification as the support start result in the step S1204.

If it is determined in the step S1201 that the received data is a video reception request (NO to the step S1201, and YES to a step S1205), the relay server 103 acquires the support session ID from the received data (step S1206).

When acquisition of the support session ID is completed, the relay server 103 verifies whether or not the acquired support session ID is included in the support session ID list (step S1207).

When the verification is completed, the verification result obtained in the step S1207 is determined (step S1208). If it is determined in the step S1208 that the acquired support session ID is not included in the support session ID list, the relay server 103 returns to the step S1201.

If it is determined in the step S1208 that the acquired support session ID is included in the support session ID list, the relay server 103 acquires video data from a data buffer associated with the support session ID acquired in the step S1206 (step S1209).

When acquisition of the video data is completed, the relay server 103 transmits the video data acquired in the step S1209 to the client (step S1210). Specifically, the client in the step S1210 is the multifunction peripheral 101. After completion of the step S1210, the relay server 103 returns to the step S1201.

If the received data is a video transmission request (NO to the step S1201, No to the step S1205, and YES to a step S1211), the relay server 103 acquires the support session ID from the data of the received video transmission request (step S1212). Specifically, the transmission source of the video transmission request in the step S1211 is the operator PC 102.

When acquisition of the support session ID is completed, the relay server 103 verifies whether or not the acquired support session ID is included in the support session ID list (step S1213).

When the verification is completed, the verification result obtained in the step S1213 is determined (step S1214).

If it is determined in the step S1214 that the acquired support session ID is not included in the support session ID list, the relay server 103 returns to the step S1201. If it is determined in the step S1214 that the acquired support session ID is included in the support session ID list, the relay server 103 acquires image data included in data of the received video transmission request as the video data (step S1215).

When acquisition of the video data is completed, the relay server 103 stores the video data in a data buffer associated with the support session ID acquired in the step S1212 (step S1216). After completion of the step S1216, the relay server 103 returns to the step S1201.

If the received data is a support end request from the multifunction peripheral 101 or the operator PC 102 (NO to the step S1201, No to the step S1205, NO to the step S1211, and YES to a step S1217), the relay server 103 proceeds to a step S1218, whereas if not, the relay server 103 proceeds to the step S1201.

In the step S1218, the relay server 103 acquires the support session ID from the received data.

When acquisition of the support session ID is completed, the relay server 103 deletes the acquired support session ID from the support session ID list (step S1219). Note that if the support session ID has already been deleted from the support session ID list, the relay server 103 directly proceeds to a step S1220 without executing the step S1219.

When deletion of the support session ID is completed, the relay server 103 transmits a support end completion notification to the client (step S1220). The client in the step S1220 is an apparatus having transmitted the support end request in the step S1217, and can be either the multifunction peripheral 101 or the operator PC 102. After completion of the step S1220, the relay server 103 returns to the step S1201.

As described above, remote support is performed via the relay server 103, which makes it unnecessary for the operator PC 102 to perform processing, including generation, storage, and verification, of the support session ID, whereby it is possible to smoothly perform remote support.

Next, a description will be given of the control for recording an operation log as an example of the log recording control performed by the multifunction peripheral 101 of the remote support system according to the present embodiment.

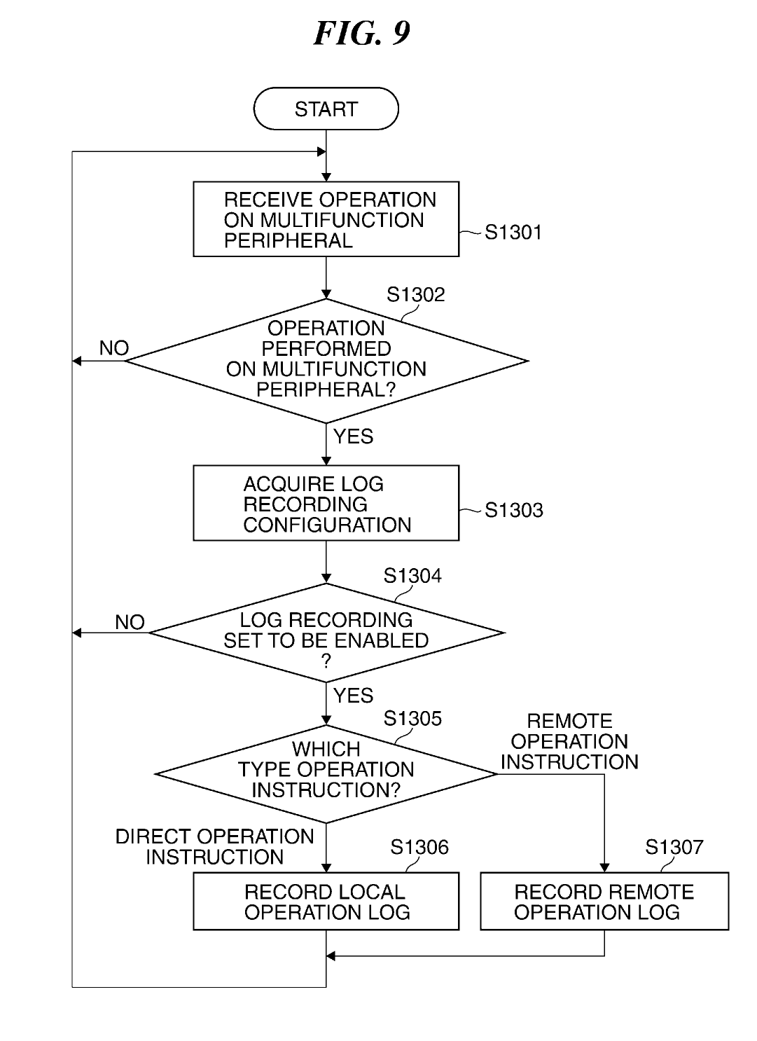

FIG. 9 is a flowchart of an operation log-recording process performed by the multifunction peripheral 101 of the remote support system according to the first embodiment.

The operation log-recording process is realized by the CPU 202 executing a program stored in the HDD 205 and loaded into the RAM 204 in a time period from the remote support start to the remote support end, defined as above.

First, the multifunction peripheral 101 receives an operation on the multifunction peripheral 101 via the operation panel 212 (step S1301).

Next, the multifunction peripheral 101 determines whether or not an operation on the multifunction peripheral 101 has been received (step S1302).

If it is determined that no operation on the multifunction peripheral 101 has been received, the multifunction peripheral 101 returns to the step S1301.

If it is determined that an operation on the multifunction peripheral 101 has been received, the multifunction peripheral 101 acquires the log recording configuration from the RAM 204 (step S1303).

Next, the multifunction peripheral 101 determines whether or not the acquired log recording configuration acquired in the step S1303 is set to enable log recording (step S1304).

If log recording is not set to be enabled, the multifunction peripheral 101 returns to the step S1301.

If log recording is set to be enabled, the multifunction peripheral 101 determines a type of operation instruction (step S1305). In the present embodiment, an operation log recorded in a case where direct operation instructions are directly given to the multifunction peripheral 101 from the operation panel 212 is referred to as the local operation log, and an operation log recorded in a case where remote operation instructions are remotely given to the multifunction peripheral 101 from the operator PC 102 via the network 106 is referred to as the remote operation log.

If it is determined that the type of operation instruction is a direct operation instruction directly given to the multifunction peripheral 101, the multifunction peripheral 101 records details of the operation in the local operation log in the HDD 205 (step S1306), and returns to the step S1301. On the other hand, if it is determined that the type of operation instruction is a remote operation instruction remotely given to the multifunction peripheral 101 from the operator PC 102, the multifunction peripheral 101 records details of the operation in the remote operation log in the HDD 205 (step S1307), and returns to the step S1301.

Note that it is assumed that a log recorded in the present embodiment is acquired by a service person of the multifunction peripheral 101 using a USB memory (not shown), or acquired by the operator of the operator PC 102 via the network 106. In a case where a log is acquired via the network 106, the log may be transmitted to a predetermined server by the multifunction peripheral 101 after remote support. Further, only a necessary log may be transmitted depending on services or information demanded by a user, e.g. by transmitting only a remote operation log and discarding a local operation log, but the log to be transmitted is not particularly limited.

Further, although in the present embodiment, a log is recorded in the HDD 202 of the multifunction peripheral 101, the log may be transmitted to the operator PC 102 of the call center when remote support is terminated, so as to be stored in the HDD 224 of the operator PC 102.

Further, logs may be stored not in the HDD 202 of the multifunction peripheral 101, but in the HDD 244 of the relay server 103. In this case, it is desirable to store logs in association with respective support session IDs, by storing support session ID information together with each log.

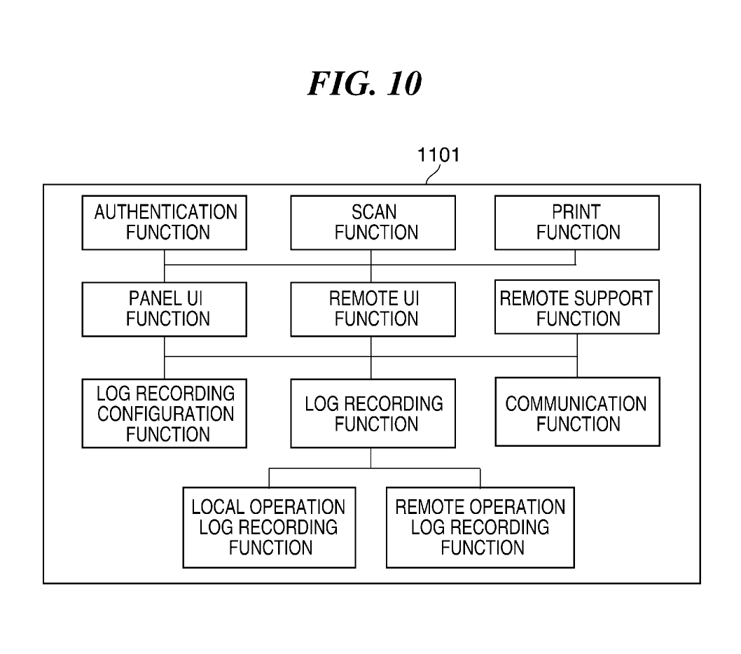

FIG. 10 is a block diagram of software functions 1101 of the multifunction peripheral 101. As described above, the multifunction peripheral 101 has functions of remote support, log recording configuration, log recording, authentication, scan, printing, panel user interface, remote user interface, local operation log recording, remote operation log recording, and so on, as described above.

The multifunction peripheral 101 uses these functions to enable settings of the log recording configuration when starting remote support so as to perform log recording control to record logs. With the log recording control, it is possible to present an audit trail of the operations performed during remote support to the user.

Next, a description will be given of a second embodiment of the present invention.

Although in the first embodiment, the logs recorded by the multifunction peripheral 101 are stored in the HDD 205 of the multifunction peripheral 101, there is a possibility that confidential information of a user of the multifunction peripheral 101 can be acquired e.g. from an operation log included in the logs stored therein. For example, if an operation log recorded when an E-mail address has been input from the operation panel 212 is acquired, it is possible to identify the E-mail address. For this reason, there are some users who do not desire to allow a third party, such as a service person, to view the log, and desire to protect the log as the confidential information, and in this case, it is necessary to obtain approval of the user to refer to the log.

In the second embodiment, the description is given of control for prompting, when remote support is started, a user to input a password for use in encrypting a log to be output before enabling the log recording function of the multifunction peripheral 101, and storing the log encrypted using the password after termination of remote support.

Note that the present embodiment is the same as the first embodiment in respect of part which is not specifically described, such as the configurations of the multifunction peripheral 101, the operator PC 102, and the relay server 103.

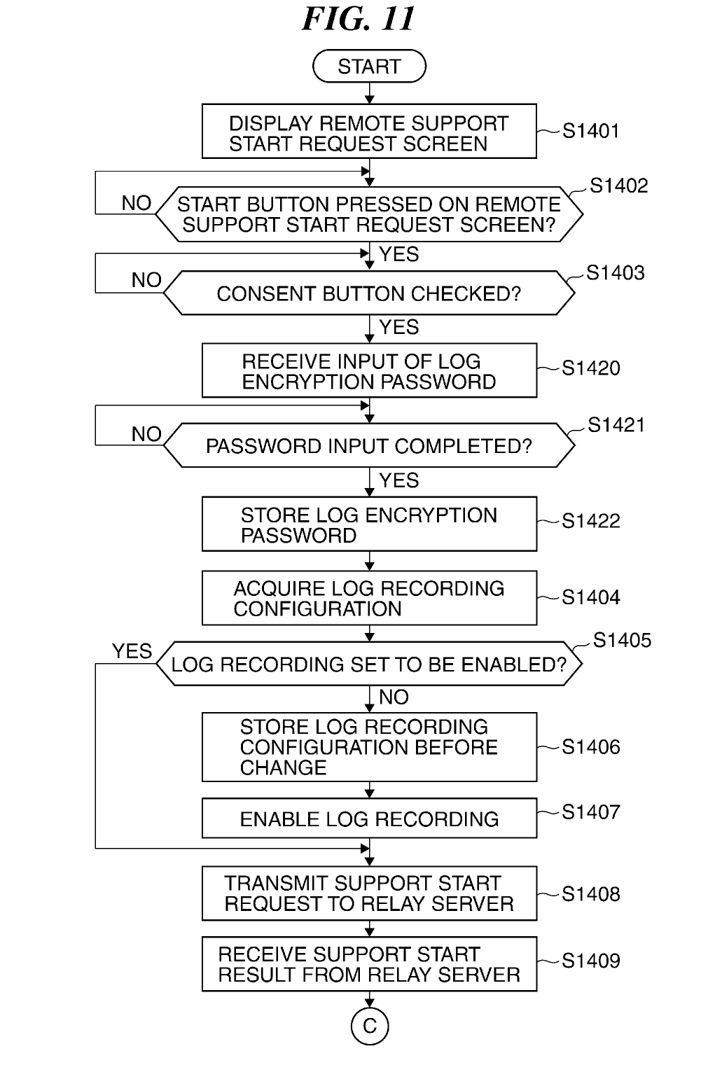

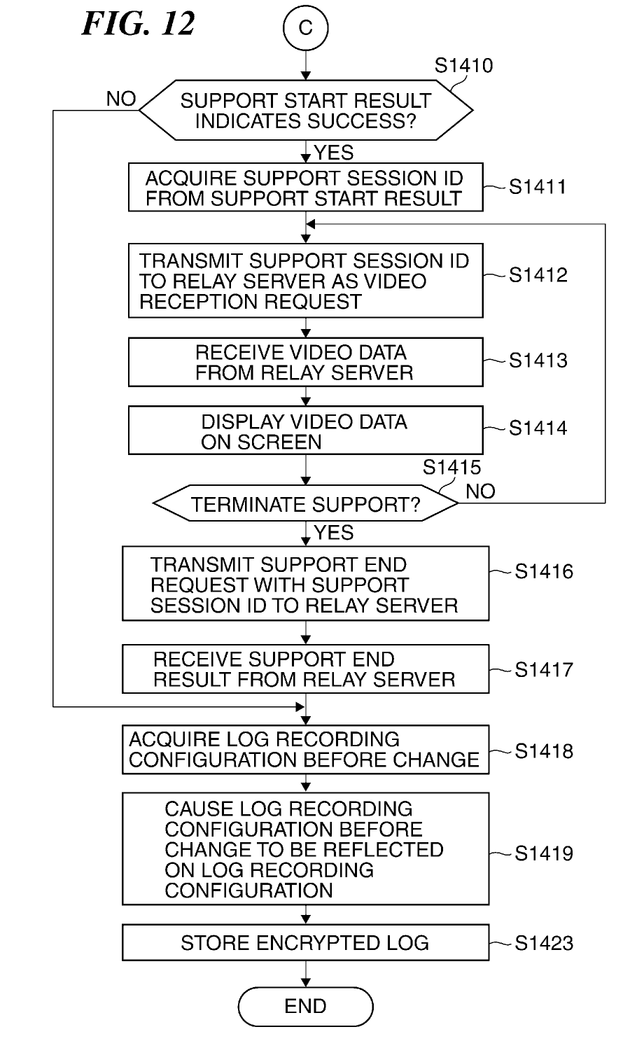

FIGS. 11 and 12 are a flowchart of a remote support process performed by the multifunction peripheral 101 in a remote support system according to the second embodiment. This remote support process is realized by the CPU 202 executing a program stored in the HDD 205 and loaded into the RAM 204.

FIGS. 11 and 12 in the present embodiment correspond to FIGS. 3 and 4 in the first embodiment, to which steps S1420 to S1423 are added. In these steps, processing for prompting a user to input a password for encrypting a log, and encrypting the log using the password is performed, and details of the processing will be described hereinafter. In steps S1401 to S1419 in FIGS. 11 and 12, the same processing as in the steps S1001 to S1019 in FIGS. 3 and 4 in the first embodiment is performed.

Hereafter, the steps in the second embodiment, as changes from the first embodiment, will be described.

If it is determined that the consent checkbox 06002, appearing in FIG. 7, is checked (YES to the step S1403), the multifunction peripheral 101 displays a log encryption-setting screen 10001 on the operation panel 212. The multifunction peripheral 101 receives an input of a password for use in encrypting a log on the displayed log encryption-setting screen 10001 (step S1420: operation of a reception unit).

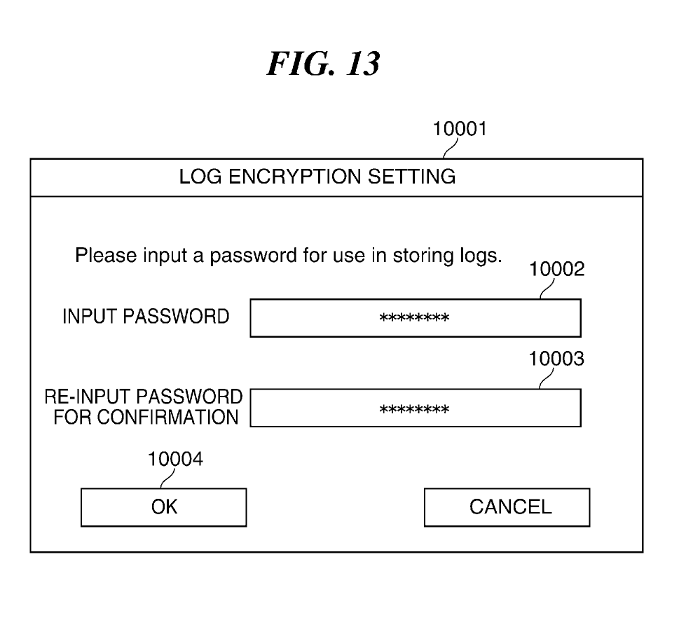

FIG. 13 shows an example of the log encryption-setting screen 10001 displayed in the step S1420 in FIG. 11. The log encryption-setting screen 10001 for remote support in the present embodiment has password input boxes 10002 and 10003. The user inputs a log encryption password via the operation panel 212, and presses an OK button 10004, whereby the CPU 202 of the multifunction peripheral 101 stores the input log encryption password in the RAM 204.

Next, the multifunction peripheral 101 determines whether or not the password has been input (step S1421).

If it is determined that the password has been input, the multifunction peripheral 101 stores the log encryption password in the RAM 204 (step S1422).

The control performed thereafter in the steps S1404 to S1419 is the same as that performed in the first embodiment, as mentioned above.

After execution of the step S1419 in FIG. 12, the multifunction peripheral 101 acquires the log encryption password from the RAM 204, encrypts the log recorded during remote support using the log encryption password, and stores the encrypted log in the HDD 205 (step S1423).

With the above-described control, when remote support for the multifunction peripheral 101 is started, an input of a password for use in encrypting a log to be output is received before enabling the log recording function of the multifunction peripheral 101, whereby it is possible to store the log encrypted using the password.

When an operator or a service person refers to a log, it is necessary to obtain approval of the user, and cause the user to input a password. If the password is unknown, the log cannot be referred to, and hence it is possible to protect the confidentiality of the log data of the user.

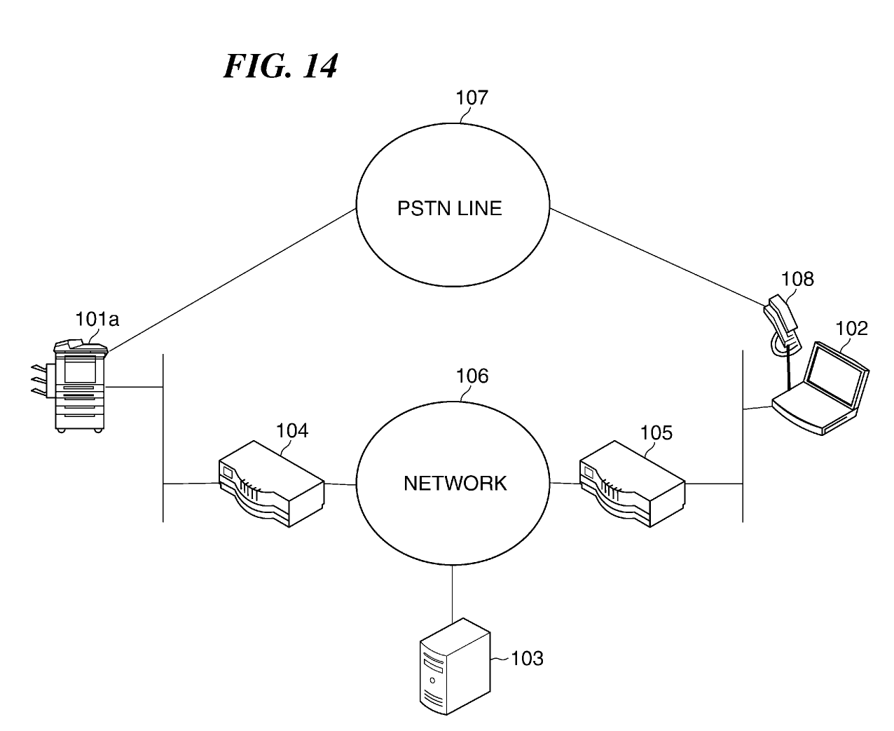

Next, a description will be given of a third embodiment of the present invention. FIG. 14 is a diagram showing network configuration of a remote support system according to the third embodiment. The same component elements of the remote support system in FIG. 14 as those of the remote support system shown in FIG. 1 are denoted by the same reference numerals, and description thereof is omitted.

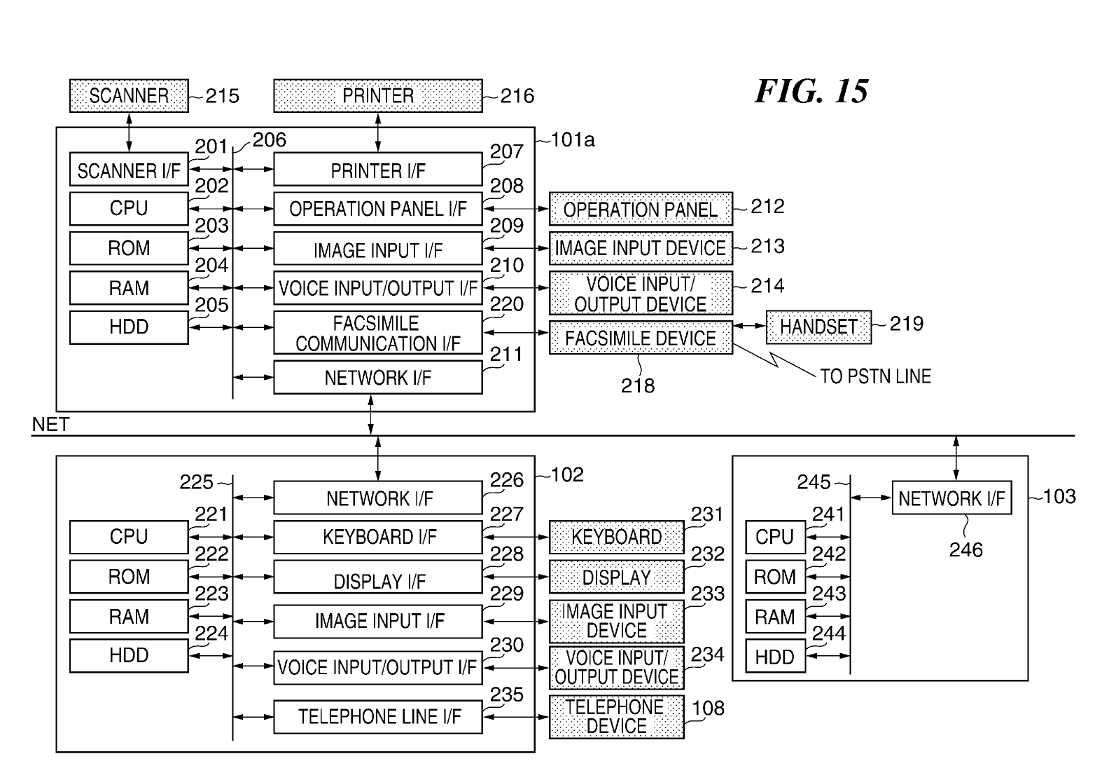

A multifunction peripheral 101a is capable of dialing a desired destination, and performing phone conversation using a handset 219, described hereinafter with reference to FIG. 15. In FIG. 14, a facsimile device 218 (see FIG. 15) attached to the multifunction peripheral 101a and a telephone device 108 of the operator PC 102 of the call center are connected to a PSTN line 107. The user of the multifunction peripheral 101a can cause the multifunction peripheral 101a to connect to the telephone device 108 by dialing the telephone number of the call center using the handset 219.

FIG. 15 is a block diagram of hardware configuration of the remote support system shown in FIG. 14. Referring to FIG. 15, the multifunction peripheral 101a includes a facsimile communication interface 220, and the facsimile device 218 and the handset 219 are attached to the multifunction peripheral 101a via the facsimile communication interface 220. Further, the operator PC 102 includes a telephone line interface 235, referred to hereinafter, and the telephone device 108 is attached to the operator PC 102 via the telephone line interface 235. Except these, the hardware configuration shown in FIG. 15 is the same as that of the remote support system shown in FIG. 2. Therefore, the same components of the remote support system in FIG. 15 as those of the remote support system in FIG. 2 are denoted by the same reference numerals, and description thereof is omitted.

The facsimile device 218 is connected to the PSTN line 107 which is a general telephone line. The user of the multifunction peripheral 101a can dial a desired destination to perform phone conversation, using the handset 219 which is a telephone device. Further, the user can transmit an image read by the scanner 215 to a desired destination by facsimile, and print an image received by facsimile, using the printer 216.

A description will be given of a flow of the overall operations of the remote support system according to the present embodiment. To receive remote support, the user of the multifunction peripheral 101a makes a call to the call center using the handset 219 as the telephone device connected to the multifunction peripheral 101a. Then, when an operator of the call center picks up the telephone device 108 in the call center, the user of the multifunction peripheral 101a and the operator of the call center enter a state capable of performing phone conversation.

Next, the user operates the multifunction peripheral 101a based on instructions from the operator to access the relay server 103, and waits for reception of video data. Then, the operator PC 102 accesses the relay server 103, and starts to transmit the video data.

With this, the multifunction peripheral 101a receives the video data, and is enabled to display the video on the operation panel 212. The following description is given of details of processing operations associated with remote support processes performed by the multifunction peripheral 101a, the operator PC 102, and the relay server 103, respectively.

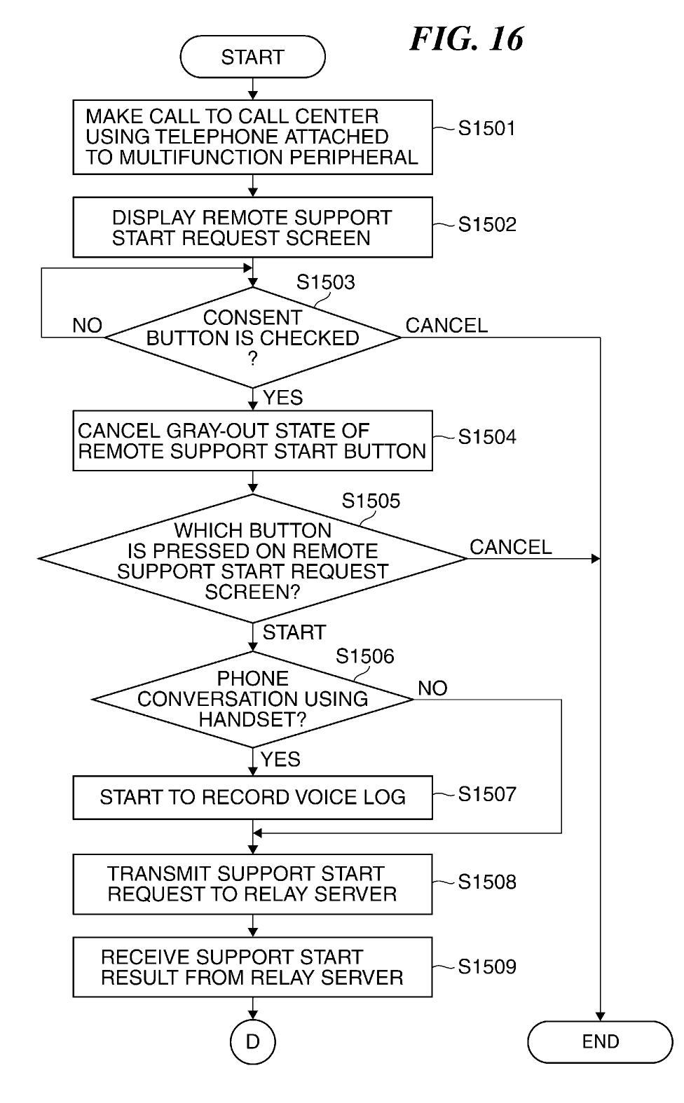

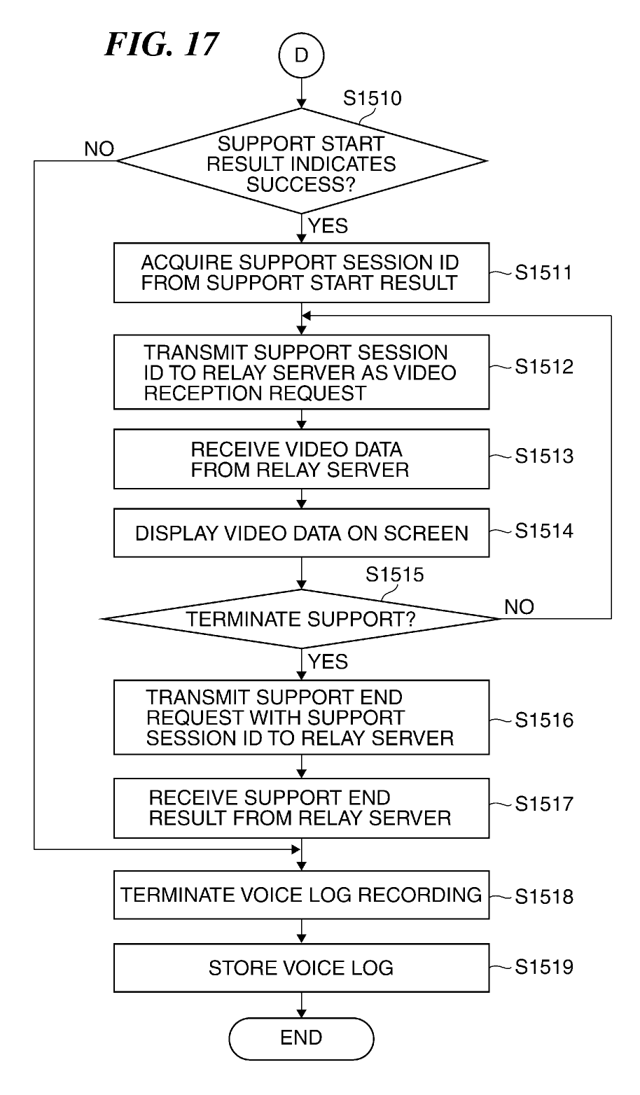

FIGS. 16 and 17 are a flowchart of a remote support process performed by the multifunction peripheral 101a, appearing in FIG. 14, of the remote support system according to the third embodiment.

This remote support process is realized by the CPU 202 executing a program stored in the HDD 205 and loaded into the RAM 204.

Referring to FIG. 16, first, in a step S1501, the user makes a call to the call center using the handset 219 as the telephone device attached to the multifunction peripheral 101a. More specifically, when the user inputs the telephone number of the call center to the handset 219, the CPU 202 of the multifunction peripheral 101a notifies the facsimile device 218 of the input telephone number via the facsimile communication interface 220. Then, the facsimile device 218 performs a calling operation according to the notified telephone number. Then, when the operator of the call center picks up the telephone device 108 as the telephone device on the call center side, phone conversation between the user and the operator is enabled.

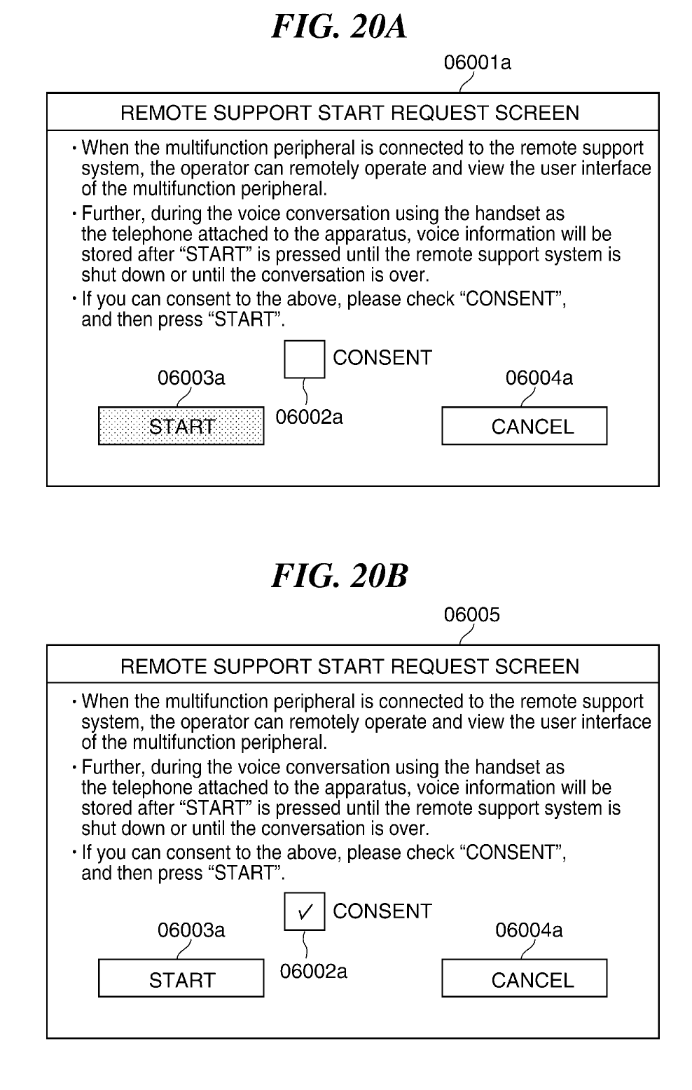

Next, in a step S1502, as a result of the telephone communication with the operator of the call center, when remote support for the multifunction peripheral 101a is started, the CPU 202 of the multifunction peripheral 101a displays a remote support start request screen 06001a (shown in FIG. 20A).

FIG. 20A shows an example of the remote support start request screen 06001a which is displayed in the step S1502, on the operation panel 212 of the multifunction peripheral 101a. The remote support start request screen 06001a in the present embodiment includes a consent checkbox 06002a, a remote support start button 06003a, and a cancel button 06004a. Further, the remote support start request screen 06001a displays notifications of points to keep in mind and points to which the user is required to consent before starting remote support. The illustrated example of the remote support start request screen 06001a displays a notification that a voice log is to be recorded when remote support is started. In the remote support start request screen 06001a having just been displayed in the step S1502, the consent checkbox 06002a is not checked yet. Further, in the state in which the consent checkbox 06002a is not checked, the remote support start button 06003a is in a grayed-out state, and cannot be pressed.

Next, in a step S1503, the CPU 202 monitors whether or not the consent checkbox 06002a is checked. If the user checks the consent checkbox 06002a, the multifunction peripheral 101a detects the check in the consent checkbox 06002a, and proceeds to a step S1504. On the other hand, if the user presses the cancel button 06004a, the multifunction peripheral 101a stops remote support, and terminates the display of the present screen 06001a, followed by terminating the present process.

Next, in the step S1504, the multifunction peripheral 101a cancels the gray-out of the remote support start button 06003a, and proceeds to a step S1505.

Next, in the step S1505, a remote support start request screen 06005 (shown in FIG. 20B) is displayed. On this screen, the remote support start button 06003a and the cancel button 06004a are both made capable of being pressed. If the remote support start button 06003a is pressed on this screen, the multifunction peripheral 101a proceeds to a step S1506. On the other hand, if the cancel button 06004a is pressed, the multifunction peripheral 101a stops remote support, and terminates the display of this screen 06005, followed by terminating the present process.

Next, in the step S1506, the multifunction peripheral 101a determines whether or not phone conversation is being performed using the handset 219 as the telephone device attached to the multifunction peripheral 101a. Then, if phone conversation is being performed, the multifunction peripheral 101a proceeds to a step S1507. On the other hand, if it is determined that phone conversation is not being performed, the multifunction peripheral 101a directly proceeds to a step S1508.

In the step S1507, the facsimile device 218 connected to the handset 219 starts to store the contents of the phone conversation between the handset 219 and the telephone device 108 in the RAM 204 as a voice log, and the multifunction peripheral 101a proceeds to the step S1508.

Although not shown, in the step S1506, it may be determined that phone conversation is being performed, by determining that the user is performing phone conversation using the handset 219, and also determining from the telephone number of the communication destination that the user is performing phone conversation with the call center. In short, if the user is performing phone conversation with the call center using the handset 219, the facsimile device 218 starts to store the voice log.

Next, in the step S1508, the multifunction peripheral 101a transmits a support start request to the relay server 103. At this time, there can be a case where the user of the multifunction peripheral 101a has been notified of a support session ID during telephone communication with the operator of the call center. In this case, the user inputs the support session ID on the support session ID input screen (not shown) displayed on the operation panel 212. In this case, the support session ID is caused to be contained in data of the transmitted support start request.

Next, in a step S1509, after transmission of the support start request is completed, the multifunction peripheral 101a receives a support start result from the relay server 103, and proceeds to a step S1510 in FIG. 17.

Referring to FIG. 17, first, in the step S1510, the multifunction peripheral 101a determines whether or not the support start result received in the step S1509 indicates a success. If the support start result indicates a failure, the multifunction peripheral 101a proceeds to a step S1518. On the other hand, if the support start result indicates a success, the multifunction peripheral 101a acquires a support session ID from the received data (step S1511).

When the support session ID has been acquired, the multifunction peripheral 101a transmits a video reception request to the relay server 103 (step S1512).

At this time, the multifunction peripheral 101a causes the support session ID acquired in the step S1511 to be contained in data of the transmitted video reception request. After transmission of the video reception request is completed, the multifunction peripheral 101a receives video data from the relay server 103 (step S1513).

The reception processing in the step S1513 is started after the operator PC 102 transmits the video data, and hence, if the operator PC 102 has not transmitted the video data yet, the multifunction peripheral 101 continues to be on standby for the reception of the video data.

Next, the multifunction peripheral 101a displays the received video data on the operation panel 212 (step S1514).

When the processing for displaying the video over a predetermined time period is terminated, the multifunction peripheral 101a determines whether or not to terminate remote support (step S1515).

This determination may be performed based on the received data, or may be performed based on an input to the operation panel 212 of the multifunction peripheral 101a. If it is determined that the support is not to be terminated, the multifunction peripheral 101a returns to the step S1512, and further receives video data. If it is determined that the support is to be terminated, the multifunction peripheral 101a transmits a support end request to the relay server 103 (step S1516).

At this time, the multifunction peripheral 101a causes the support session ID acquired in the step S1511 to be contained in data of the transmitted support end request. After transmission of the support end request is completed, the multifunction peripheral 101a receives a support end result from the relay server 103 (step S1517).

Next, in the step S1518, the multifunction peripheral 101a terminates temporary recording of the voice log in the RAM 204 by the facsimile device 218.

Then, in a step S1519, the multifunction peripheral 101a stores the voice log in the HDD 205, which has been temporarily recorded in the RAM 204, starting from the step S1507 and terminating in the step S1518.

In the present embodiment, a time at which the multifunction peripheral 101a transmits the support start request to the relay server 103 in the step S1508 is defined as a remote support start, and a time at which the multifunction peripheral 101a receives the support end result from the relay server 103 in the step S1517 is defined as a remote support end. Then, the voice log recorded during remote support is stored. However, the definitions of the remote support start and the remote support end are not limited to these, but they may be defined using another time period (section). For example, a time at which phone conversation using the handset 219 is started in the step S1501 may be defined as the remote support start to start recording of the voice log. Further, a time at which phone conversation using the handset 219 is terminated may be defined as the remote support end to store the voice log recorded so far.

Further, although in the present embodiment, the voice log is stored in the multifunction peripheral 101a, the voice log may be transmitted to the operator PC 102 of the call center when remote support is terminated, so as to store the same in the HDD 224 of the operator PC 102.

Further, the contents of phone conversation between the user of the multifunction peripheral 101a and the operator may be stored, as the voice log, not in the HDD 202 of the multifunction peripheral 101a, but in the HDD 244 of the relay server 103. In this case, it is desirable to store voice logs in association with respective support session IDs, by storing support session ID information together with each voice log.

It is possible to reduce the risk of loss of voice logs by making use of a plurality of voice log-storing methods described above, and further, even when the multifunction peripheral 101a performs an operation involving the power on/off operation according to remote support, it is possible to store voice from the operator PC 102 in the voice log.

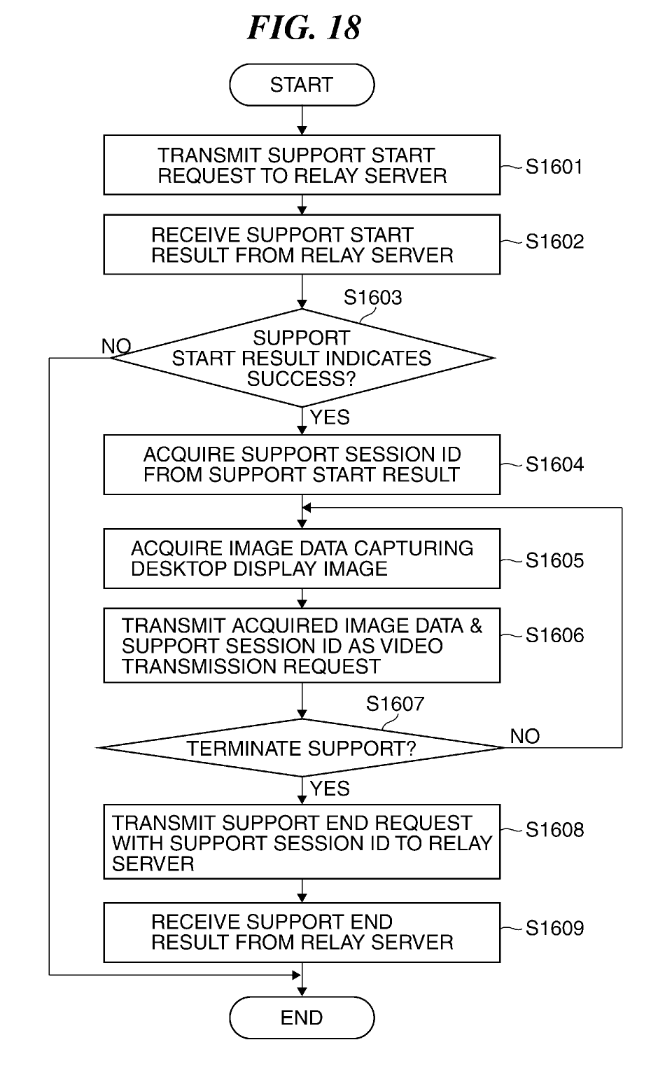

FIG. 18 is a flowchart of a remote support process performed by the operator PC 102, appearing in FIG. 14, of the remote support system according to the third embodiment. This remote support process is realized by the CPU 221 executing a program stored in the HDD 224 and loaded into the RAM 223.

First, the operator PC 102 transmits a support start request to the relay server 103 (step S1601). This support start request is transmitted when the call center gets a call for requesting remote support for the multifunction peripheral 101a from a user who is attending the multifunction peripheral 101a, using the handset 219. Further, at this time, in a case where the operator of the operator PC 102 has been informed of a support session ID from the user of the multifunction peripheral 101a via the telephone, the operator inputs the informed support session ID on the support session ID input screen (not shown) displayed on the display 232. In this case, the support session ID is caused to be contained in data of the transmitted support start request.

After transmission of the support start request is completed, the operator PC 102 receives a support start result from the relay server 103 (step S1602).

Next, the operator PC 102 determines whether or not the support start result received in the step S1602 indicates a success (step S1603). If the support start result indicates a failure, the present process is immediately terminated.

On the other hand, if the support start result indicates a success, the operator PC 102 acquires a support session ID from the received data (step S1604).

When the support session ID has been acquired, the operator PC 102 acquires image data capturing an image of a desktop display screen displayed on the display 232 thereof (step S1605).

When acquisition of the image data is completed, the operator PC 102 transmits a video transmission request to the relay server 103 (step S1606). At this time, the support session ID acquired in the step S1604 and the image data acquired in the step S1605 are caused to be contained in data of the transmitted video transmission request. This image data is transmitted to the multifunction peripheral 101a via the relay server 103 as the video data. The operator of the operator PC 102 performs remote support for the multifunction peripheral 101a using the video data.

The steps S1605 and S1606 are repeated until it is determined in a step S1607 that the support is to be terminated.

If it is determined in the step S1607 that the support is to be terminated, the operator PC 102 transmits a support end request to the relay server 103 (step S1608). At this time, the operator PC 102 causes the support session ID acquired in the step S1604 to be contained in data of the transmitted support end request.

After transmission of the support end request is completed, the operator PC 102 receives a support end result from the relay server 103 (step S1609), followed by terminating the present process.

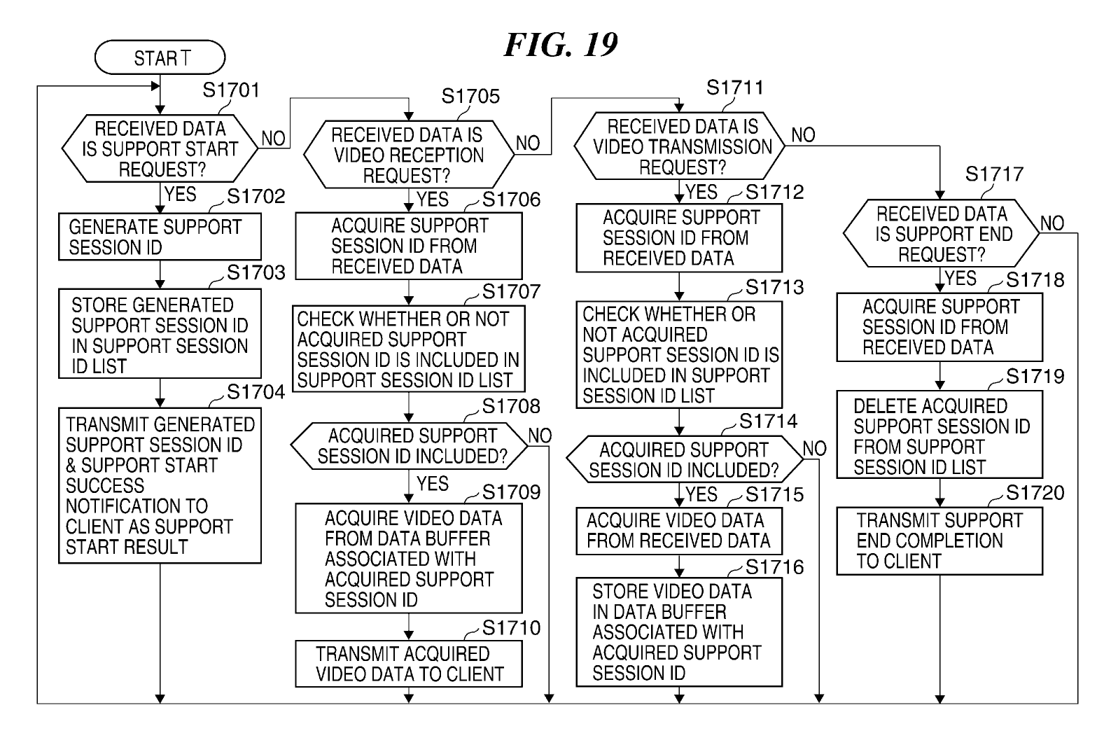

FIG. 19 is a flowchart of a remote support process performed by the relay server 103, appearing in FIG. 14, of the remote support system according to the third embodiment. This remote support process is realized by the CPU 241 executing a program stored in the HDD 244 and loaded into the RAM 243.

If the data received by the relay server 103 is a support start request transmitted from the multifunction peripheral 101a or the operator PC 102 (YES to a step S1701), the relay server 103 generates a support session ID (step S1702).

The relay server 103 stores the support session ID generated in the step S1702 in the support session ID list (step S1703).

The relay server 103 transmits the support session ID generated in the step S1702 to the client as the support start result (step S1704). The client in the step S1704 is an apparatus having transmitted the support start request in the step S1701, and can be either of the multifunction peripheral 101a and the operator PC 102. After transmission of the support session ID in the step S1704 is completed, the relay server 103 returns to the step S1701.

Note that in a case where a support session ID is contained in the data of the support start request received in the step S1701, the support session ID is not generated in the step S1702, and the relay server 103 determines whether or not the received support session ID has already been stored in the support session ID list. If it is determined that the received support session ID has already been stored, the relay server 103 transmits the stored support session ID and the support start success notification as the support start result in the step S1704. On the other hand, if the received support session ID has not been stored, the relay server 103 transmits the support start failure notification as the support start result in the step S1704.

If the received data is a video reception request (NO to the step S1701, and YES to a step S1705), the relay server 103 acquires a support session ID from the received data (step S1706).

When acquisition of the support session ID is completed, the relay server 103 verifies whether or not the acquired support session ID is included in the support session ID list (step S1707).

When the verification is completed, the verification result obtained in the step S1707 is determined (step S1708). If it is determined in the step S1708 that the acquired support session ID is not included in the support session ID list, the relay server 103 returns to the step S1701.

If it is determined in the step S1708 that the acquired support session ID is included in the support session ID list, the relay server 103 acquires video data from a data buffer associated with the support session ID acquired in the step S1706 (step S1709).

When acquisition of the video data is completed, the relay server 103 transmits the video data acquired in the step S1709 to the client (step S1710). More specifically, the client in the step S1710 is the multifunction peripheral 101a. After completion of the step S1710, the relay server 103 returns to the step S1701.

If the received data is a video transmission request (NO to the step S1701, No to the step S1705, and YES to a step S1711), the relay server 103 acquires a support session ID from the data of the received video transmission request (step S1712). More specifically, in the step S1711, the video transmission request is transmitted by the operator PC 102.

When acquisition of the support session ID is completed, the relay server 103 verifies whether or not the acquired support session ID is included in the support session ID list (step S1713).

When the verification is completed, the verification result obtained in the step S1713 is determined (step S1714).

If it is determined in the step S1714 that the acquired support session ID is not included in the support session ID list, the relay server 103 returns to the step S1701. If it is determined in the step S1714 that the acquired support session ID is included in the support session ID list, the relay server 103 acquires image data included in data of the received video transmission request as the video data (step S1715).

When the video data has been acquired, the relay server 103 stores the video data in a data buffer associated with the support session ID acquired in the step S1712 (step S1716). After completion of the step S1716, the relay server 103 returns to the step S1701.

If the received data is a support end request from the multifunction peripheral 101a or the operator PC 102 (NO to the step S1701, No to the step S1705, NO to the step S1711, and YES to a step S1717), the relay server 103 proceeds to a step S1718.

In the step S1718, the relay server 103 acquires a support session ID from the received data.

When acquisition of the support session ID is completed, the relay server 103 deletes the acquired support session ID from the support session ID list (step S1719). Note that if the support session ID has already been deleted from the support session ID list, the relay server 103 directly proceeds to a step S1720 without executing the step S1719.

When deletion of the support session ID is completed, the relay server 103 transmits a support end completion notification to the client (step S1720). The client in the step S1720 is an apparatus having transmitted the support end request in the step S1717, and can be either of the multifunction peripheral 101a and the operator PC 102. After completion of the step S1720, the relay server 103 returns to the step S1701.

As described above, remote support is performed via the relay server 103, which makes it unnecessary for the operator PC 102 to perform processing, including generation, storage, and verification, of the support session ID, whereby it is possible to smoothly perform remote support.

As described above, the control for recording a voice log is performed when remote support for the multifunction peripheral 101a is started. By performing the above-described control, it is possible to present an audit trail of the phone conversation performed during remote support to the user.

Although in the present embodiment, the telephone device 108 which can be connected to the PSTN line 107 is described as the telephone device by way of example, the telephone device is not limited to a telephone device connected to the PSTN line 107 which is a general telephone line, but may be a telephone device using the Internet, such as an IP telephone.

Next, a description will be given of a fourth embodiment of the present invention.

Although in the third embodiment, the voice logs recorded by the multifunction peripheral 101a are stored in the HDD 205 of the multifunction peripheral 101a, there is a possibility that the confidential information of a user of the multifunction peripheral 101a can be acquired from the voice logs stored therein. For this reason, there are some users who do not desire to allow a third party, such as a service person, to view the voice log, and desire to protect the voice log as the confidential information, and in this case, it is necessary to obtain approval of the user to refer to the voice log.

In the fourth embodiment, the description is given of control for prompting, when remote support is started, a user to input a password for encrypting a voice log which is recorded, before enabling the voice log recording function of the multifunction peripheral 101a, and storing, when remote support is terminated, the voice log after encrypting the same using the password.

Note that the present embodiment is the same as the third embodiment in respect of part which is not specifically described, such as the configurations of the multifunction peripheral 101a, the operator PC 102, and the relay server 103.

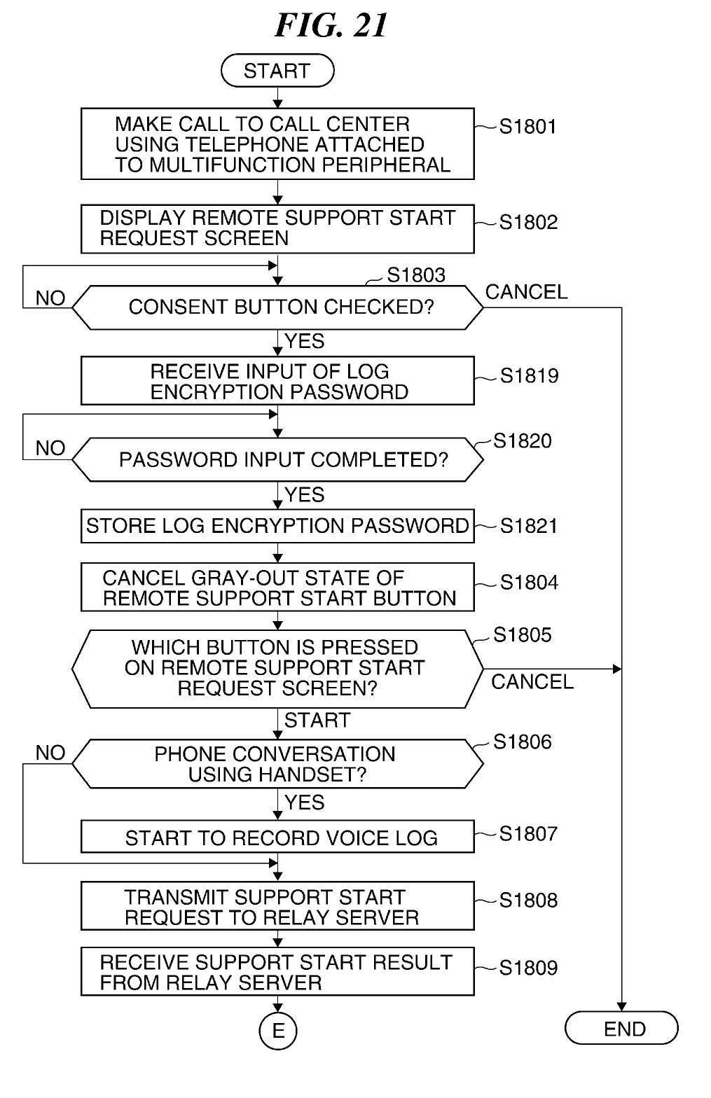

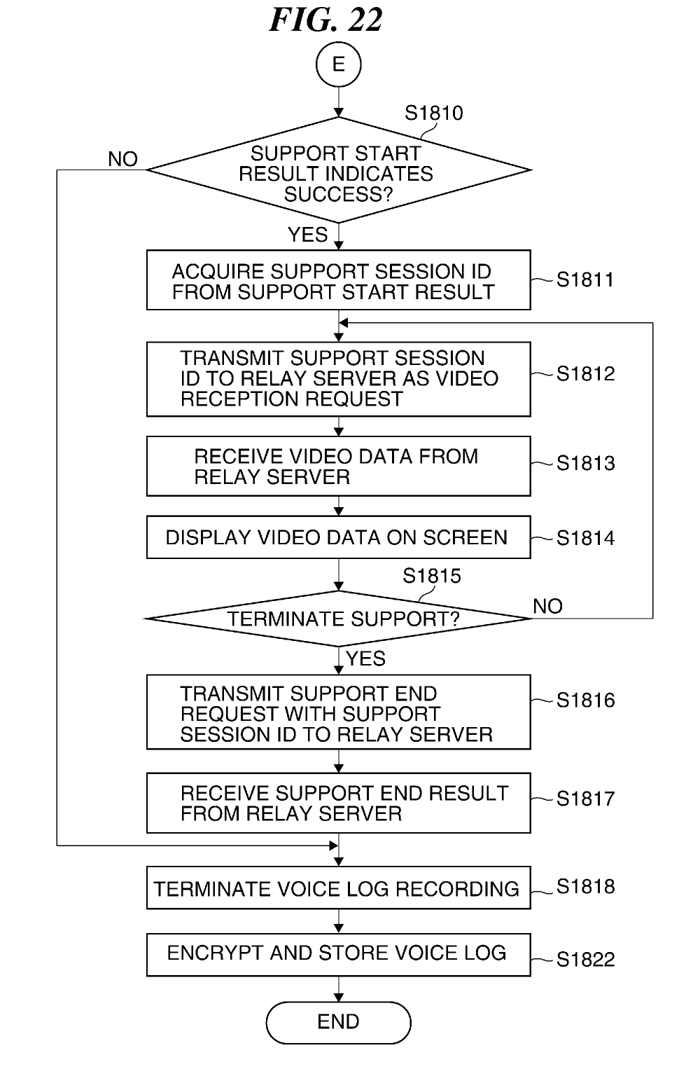

FIGS. 21 and 22 are a flowchart of a remote support process performed by the multifunction peripheral 101a of the remote support system according to the fourth embodiment. This remote support process is realized by the CPU 202 executing a program stored in the HDD 205 and loaded into the RAM 204.

FIGS. 21 and 22 in the present embodiment correspond to FIGS. 16 and 17 in the third embodiment, from which the step S1519 is omitted and to which steps S1819 to S1822 are added. In these added steps S1819 to S1822, processing for prompting a user to input a password for encrypting a log and processing for encrypting the log using the password are performed, and details of the processing will be described hereinafter. In steps S1801 to S1818 in FIGS. 21 and 22, the same processing as in the steps S1501 to S1518 in FIGS. 16 and 17 in the third embodiment is performed.

Hereafter, the steps in the fourth embodiment, as changes from the third embodiment, will be described.

If it is determined that the consent checkbox 06002a in FIG. 20 is checked (YES to the step S1803), the multifunction peripheral 101a displays a log encryption-setting screen 10001a on the operation panel 212. The multifunction peripheral 101a receives an input of a password for encrypting a log on the log encryption-setting screen 10001a (step S1819).

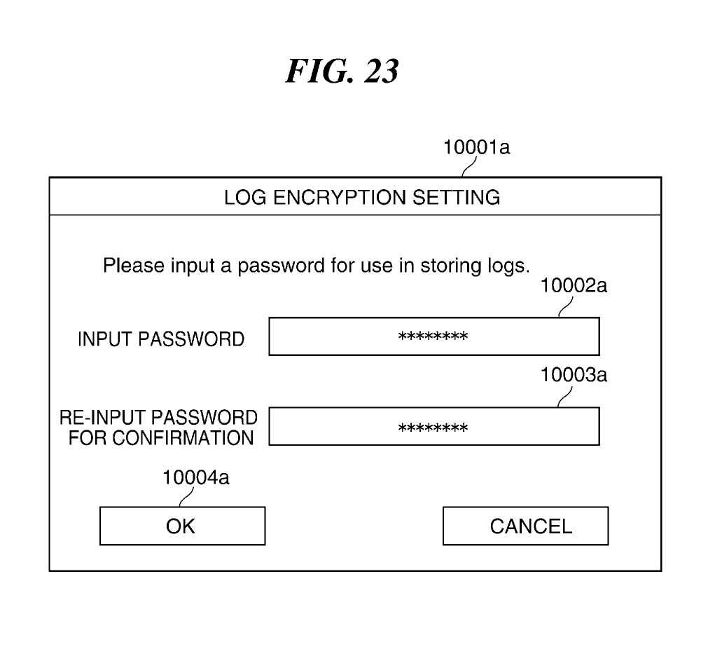

FIG. 23 shows an example of the log encryption-setting screen 10001a displayed in the step S1819 in FIG. 21. The log encryption-setting screen for remote support in the present embodiment has password input boxes 10002a and 10003a. The user inputs a log encryption password via the operation panel 212, and presses an OK button 10004a, whereby the CPU 202 of the multifunction peripheral 101a stores the input log encryption password in the RAM 204.

Next, the multifunction peripheral 101a determines whether or not a password has been input (step S1820).

If it is determined that a password has been input, the multifunction peripheral 101a stores the log encryption password in the RAM 204 (step S1821).

After that, the control performed in the steps S1804 to S1818 is the same as that in the third embodiment.

After execution of the step S1818, the multifunction peripheral 101a acquires the log encryption password from the RAM 204, encrypts the recorded voice log using the log encryption password, and stores the encrypted log in the HDD 205 (step S1822).

With the above-described control in the steps S1819 to S1822, when remote support for the multifunction peripheral 101a is started, an input of a password for use in encrypting a voice log is received, whereby it is possible to store the voice log encrypted using the password.

When an operator or a service person refers to the voice log, it is necessary to obtain approval of the user, and cause the user to input a password. Unless the password is known, the voice log cannot be referred to, and hence it is possible to protect the confidentiality of the voice log data.

In the above-described first to fourth embodiments, the multifunction peripheral 101 or 101a receives remote support of the operator PC 102 via the relay server 103 that performs processing, including generation, storage, and verification, of the support session ID. However, this is not limitative. For example, the operator PC 102 may be configured to also perform the processing performed by the relay server 103, and thereby perform remote support for the multifunction peripheral 101 or 101a via the firewalls 104 and 105 and the network 106, without via the relay server 103.

### OTHER EMBODIMENTS

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2017-010397 filed Jan. 24, 2017, which is hereby incorporated by reference herein in its entirety.

What is claimed is:

1. An information processing apparatus for which remote support is performed by a remote supporting apparatus connected thereto via a network, comprising:
a log recording unit configured to record a log of operations performed in the remote supporting apparatus and the information processing apparatus; and
an enabling unit configured to enable the log recording unit,
wherein the enabling unit enables the log recording unit in a time period from start to end of the remote support.

2. The information processing apparatus according to claim 1, further comprising a transmission unit configured to transmit a request for starting the remote support via the network, and
a reception unit configured to receive a result of the end of the remote support via the network, and
wherein the remote support is started when the request for starting the remote support is transmitted, and is terminated when the result of the end of the remote support is received.

3. The information processing apparatus according to claim 1, further comprising an acquisition unit configured to acquire approval from a user, for recording the log during the remote support, and
wherein the remote support is started when the approval is acquired by the acquisition unit.

4. The information processing apparatus according to claim 1, further comprising a determination unit configured to determine whether an operation performed during the remote support is an operation performed from the information processing apparatus or an operation performed from the remote supporting apparatus, and
wherein when remote support is started, the determination unit determines whether a received operation is an operation performed from the information processing apparatus or an operation performed from remote supporting apparatus, and the log recording unit records the log according to the determined operation.

5. The information processing apparatus according to claim 1, further comprising:
an encryption unit configured to encrypt the log, and
a reception unit configured to receive an input of a password which is used by the encryption unit, and
wherein after the remote support is started, the reception unit receives an input of a password, and the encryption unit encrypts a log recorded by the log recording unit.

6. The information processing apparatus according to claim 1, further comprising a telephone device which is capable of performing phone conversation with the remote supporting apparatus, and
wherein the log is a voice log storing contents of the phone conversation, and
wherein the remote support is started when the phone conversation using the telephone device is started.

7. A remote support system that connects a remote supporting apparatus and an information processing apparatus for which remote support is performed, via a network, comprising:
a log recording unit configured to record a log of operations in the remote supporting apparatus and the information processing apparatus, by a recording device connected thereto via the network; and
an enabling unit configured to enable the log recording unit, by the information processing apparatus,
wherein the enabling unit enables the log recording unit in a time period from start to end of the remote support.

8. A method of controlling an information processing apparatus for which remote support is performed by a remote supporting apparatus connected thereto via a network, comprising:
recording a log of operations in the remote supporting apparatus and the information processing apparatus; and
enabling said recording of the log,
wherein said recording of the log is enabled in a time period from start to end of the remote support.

9. A method of controlling a remote support system that connects a remote supporting apparatus and an information processing apparatus for which remote support is performed, via a network, comprising:
recording a log of operations in the remote supporting apparatus and the information processing apparatus, in a recording device connected to the network; and
enabling said recording of the log, in the information processing apparatus,
wherein said recording of the log is enabled in a time period from start to end of the remote support.

10. A non-transitory computer-readable storage medium storing a computer-executable program for executing a method of controlling an information processing apparatus for which remote support is performed by a remote supporting apparatus connected thereto via a network,
wherein the method comprises:
recording a log of operations in the remote supporting apparatus and the information processing apparatus; and
enabling said recording of the log,
wherein said recording of the log is enabled in a time period from start to end of the remote support.

11. A non-transitory computer-readable storage medium storing a computer-executable program for executing a method of controlling a remote support system that connects a remote supporting apparatus and an information processing apparatus for which remote support is performed, via a network,
wherein the method comprises:
recording a log of operations in the remote supporting apparatus and the information processing apparatus, in a recording device connected to the network; and
enabling said recording of the log, in the information processing apparatus,
wherein said recording of the log is enabled in a time period from start to end of the remote support.
